(19) United States
(12) Patent Application Publication
(10) Pub. No.: US 2006/0088279 A1
(43) Pub. Date: Apr. 27, 2006

(54) Reproduction apparatus, data processing system, reproduction method, program, and storage medium

(75) Inventors: Shuji Tsunashima, Tokyo (JP); Shojiro Shibata, Kanagawa (JP); Mototsugu Takamura, Kanagawa (JP); Kyohei Koyabu, Kanagawa (JP); Shinjiro Kakita, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/253,685

(22) Filed: Oct. 20, 2005

(30) Foreign Application Priority Data
Oct. 26, 2004 (JP) 2004-311596
Aug. 24, 2005 (JP) 2005-243292

(51) Int. Cl. H04N 5/781

(52) U.S. Cl. 386/46; 386/125

(57) ABSTRACT

A reproduction apparatus for decoding and reproducing a plurality of picture data forming reproduced data in order, comprising a reproduction memory, a decoder for decoding the picture data, writing decoding results in the reproduction memory, and reproducing and outputting the decoding results read from the reproduction memory, and a processing circuit for performing decoding scheduling for determining an order of decoding the picture data at the decoder in predetermined units of a plurality of the picture data, selecting the picture data to be processed in the order determined by the decoding scheduling, determining whether to decode the selected picture data or reproduce and output the decoding results in accordance with a designated reproduction rate, and controlling the decoding and the reproduction and output of the decoder based on the decision.

### CROSS REFERENCES TO RELATED APPLICATIONS

The present invention contains subject matter related to Japanese Patent Applications No. 2004-311596 filed on Oct. 26, 2004 and No. 2005-243292 filed on Aug. 24, 2005 in the Japan Patent Office, the entire contents of which being incorporated herein by reference.

### BACKGROUND OF THE INVENTION

1. Field of the Invention

The present invention relates to a reproduction apparatus, data processing system, reproduction method, program, and storage medium for reproducing reproduced data.

2. Description of the Related Art

For example, there is a reproduction apparatus which decodes and reproduces reproduced data encoded by the MPEG (Moving Picture Experts Group) scheme. Such a reproduction apparatus, for example, performs decoding scheduling for determining a timing and order of decoding picture data selected in accordance with a reference relationship of picture data and a reproduction rate in units of groups of I, P, and B picture data forming the reproduced data (GOP) and decodes the picture data and reproduces and outputs the decoding results in accordance with the results of the decoding scheduling. In this reproduction apparatus, for example, when receiving a command for change of the reproduction rate, in the decoding scheduling of the next GOP after the GOP being reproduced, results of decoding scheduling are generated corresponding to the changed reproduction rate. For reference, see Japanese Patent Publication (A) No. 2003-101967.

However, in the reproduction apparatus of the above related art, when receiving a command for changing the reproduction rate, since results of decoding scheduling corresponding to the changed reproduction rate are generated in the decoding scheduling of the next GOP after the GOP being reproduced, reproduction and output corresponding to the changed reproduction rate only are obtained in the next GOP after the GOP being decoded and reproduced and output when receiving the change command. Therefore, a long time is taken from when receiving the command for changing the reproduction rate to when reproduction and output corresponding to the changed reproduction rate are obtained, that is, there is the disadvantage that the response is poor.

### SUMMARY OF THE INVENTION

An object of the present invention is to provide a reproduction apparatus, data processing system, reproduction method, program, and storage medium able to shorten, compared with the related art, the time from when receiving a command for changing the reproduction rate to when obtaining reproduction and output corresponding to the changed reproduction rate when successively decoding and reproducing and outputting a plurality of picture data.

According to a first aspect of the invention, there is provided a reproduction apparatus for decoding and reproducing a plurality of picture data forming reproduced data in order, comprising a reproduction memory, a decoder for decoding the picture data, writing decoding results in the reproduction memory, and reproducing and outputting the decoding results read from the reproduction memory, and a processing circuit for performing decoding scheduling for determining an order of making the decoder decode the picture data in predetermined units of a plurality of the picture data, selecting the picture data to be processed in the order determined by the decoding scheduling, determining whether to decode the selected picture data or reproduce and output the decoding results in accordance with a designated reproduction rate, and controlling the decoding and the reproduction and output of the decoder based on the decision.

The processing circuit performs decoding scheduling for determining an order of making the decoder decode the picture data in predetermined units of a plurality of the picture data. Further, the processing circuit selects the picture data to be processed in the order determined by the decoding scheduling. The processing circuit then determines whether to decode the selected picture data or reproduce and output the decoding results in accordance with a designated reproduction rate and controls the decoding and the reproduction and output of the decoder based on the decision.

According to a second aspect of the invention, there is provided a data processing system comprising a data processing apparatus for outputting a plurality of picture data forming reproduced data to a reproduction apparatus and a reproduction apparatus for successively decoding and reproducing a plurality of picture data input from the data processing apparatus, the reproduction apparatus comprising an input memory for storing the picture data input from the data processing apparatus, a reproduction memory, a decoder decoding the picture data read from the input memory, writing the decoding results in the reproduction memory, and reproducing and outputting the decoding results read from the reproduction memory, and a processing circuit for performing decoding scheduling for determining the order of making the decoder decode the picture data in units of a predetermined plurality of the picture data, selecting the picture data to be processed in the order determined by the decoding scheduling, determining whether to decode the selected picture data or reproduce or output the decoding results in accordance with a designated reproduction rate, and controlling the decoding and the reproduction and output of the decoder based on that determination.

According to a third aspect of the invention, there is provided a reproduction method for successively decoding and reproducing a plurality of picture data forming reproduced data, comprising a first step of performing decoding scheduling for determining an order of decoding the picture data in units of a predetermined plurality of the picture data, a second step of selecting the picture data to be processed in the order determined by the decoding scheduling at the first step, a third step of determining whether to decode the picture data selected at the second step or reproduce and output the decoding results in accordance with a designated reproduction rate, and a fourth step of controlling the decoding and the reproduction and output of the decoding results based on the determination of the third step.

According to a fourth aspect of the invention, there is provided a reproduction method comprising a first step for outputting a plurality of picture data forming reproduced data from a data processing apparatus to a reproduction apparatus, a second step of having the reproduction apparatus perform decoding scheduling for determining an order of decoding picture data input from the data processing apparatus in the first step in units of a predetermined plurality of the picture data, a third step of selecting the picture data being processed in the order determined by the decoding scheduling performed at the second step, a fourth step of determining whether or not to decode the picture data selected at the third step or reproduce and output the decoding results in accordance with a designated reproduction rate, and a fifth step of controlling the decoding and the reproduction and output of the decoding results based on the determination at the fourth step.

According to a fifth aspect of the invention, there is provided a program executed by a reproduction apparatus successively decoding and reproducing a plurality of picture data forming reproduced data, comprising a first routine of performing decoding scheduling for determining an order of decoding picture data in units of a predetermined plurality of the picture data, a second routine of selecting the picture data being processed in the order determined by the decoding scheduling performed at the first routine, a third routine of determining whether or not to decode the picture data selected at the second routine or reproduce and output the decoding results in accordance with a designated reproduction rate, and a fourth routine of controlling the decoding and the reproduction and output of the decoding results based on the determination at the third routine.

According to a sixth aspect of the invention, there is provided a storage medium storing a program executed by a reproduction apparatus successively decoding and reproducing a plurality of picture data forming reproduced data, the program comprising a first routine of performing decoding scheduling for determining an order of decoding picture data in units of a predetermined plurality of the picture data, a second routine of selecting the picture data being processed in the order determined by the decoding scheduling performed at the first routine, a third routine of determining whether or not to decode the picture data selected at the second routine or reproduce and output the decoding results in accordance with a designated reproduction rate, and a fourth routine of controlling the decoding and the reproduction and output of the decoding results based on the determination at the third routine.

According to a seventh aspect of the invention, there is provided a data processing apparatus comprising a storage medium storing a plurality of picture data forming reproduced data, a reading means for reading the picture data from the storage medium, an input memory for storing the picture data read by the reading means, a reproduction memory, a decoder for decoding the picture data read from the input memory, writing the decoding results in the reproduction memory, and reproducing and outputting the decoding results read from the reproduction memory, and a processing circuit for performing decoding scheduling for determining the order of making the decoder decode the picture data in units of a predetermined plurality of the picture data, selecting the picture data to be processed in the order determined by the decoding scheduling, determining whether to decode the selected picture data or reproduce or output the decoding results in accordance with a designated reproduction rate, and controlling the decoding and the reproduction and output of the decoder based on that determination.

According to the present invention, it is possible to provide a reproduction apparatus, data processing system, reproduction method, program, and storage medium able to shorten, compared with the related art, the time from when receiving a command for changing the reproduction rate to when reproduction and output corresponding to the changed reproduction rate are obtained in the case of successively decoding and reproducing a plurality of picture data.

### BRIEF DESCRIPTION OF THE DRAWINGS

These and other objects and features of the present invention will become clearer from the following description of the preferred embodiments given with reference to the attached drawings, wherein:

FIG. 1 is a view of the overall configuration of a data processing system according to a first embodiment of the present invention;

FIG. 2 is a view for explaining reproduced data ENC to be decoded by the data processing system shown in FIG. 1;

FIG. 3 is a view of decoding by decoders 34_1, 34_2, and 34_3, the storage states of reproduction memories 36_1 to 36_3, and reproduction and output in the case of reproducing reproduced data ENC shown in FIG. 2 in a forward direction;

FIG. 4 is a view following FIG. 3 of decoding by decoders 34_1, 34_2, and 34_3, the storage states of reproduction memories 36_1 to 36_3, and reproduction and output in the case of reproducing reproduced data ENC shown in FIG. 2 in a forward direction;

FIG. 5 is a flow chart for explaining an example of the overall operation of the data processing system shown in FIG. 1;

FIG. 6 is a flow chart following FIG. 4 for explaining an example of the overall operation of the data processing system shown in FIG. 1;

FIG. 7 is a flow chart following FIG. 6 for explaining an example of the overall operation of the data processing system shown in FIG. 1;

FIG. 8 is a view for explaining an example of operation of a reproduction apparatus in the case where the reproduction rate is changed in the order of 1.5× speed reproduction, 3× speed reproduction, and 1× speed reproduction when performing the forward (FWD) 1× speed reproduction shown in FIG. 3 and FIG. 4;

FIG. 9 is a view following FIG. 8 for explaining an example of operation of a reproduction apparatus in the case where the reproduction rate is changed in the order of 1.5× speed reproduction, 3× speed reproduction, and 1× speed reproduction when performing the forward (FWD) 1× speed reproduction shown in FIG. 3 and FIG. 4;

FIG. 10 is a view of the overall configuration of a data processing system according to a second embodiment of the present invention;

FIG. 11 is a view for explaining an operation in which the data processing system shown in FIG. 10 reproduces reproduced data ENC in the reverse (REV) direction;

FIG. 12 is a view following FIG. 11 for explaining an operation in which the data processing system shown in FIG. 10 reproduces reproduced data ENC in the reverse (REV) direction;

FIG. 13 is a view for explaining the case of changing the reproduction rate from 1× speed reverse reproduction shown in FIG. 11 to 1.5× speed reverse reproduction, 3× speed reverse reproduction, and 1× speed reverse reproduction in that order in the data processing system shown in FIG. 10;

FIG. 14 is a view following FIG. 13 for explaining the case of changing the reproduction rate from 1× speed reverse reproduction shown in FIG. 11 to 1.5× speed reverse reproduction, 3× speed reverse reproduction, and 1× speed reverse reproduction in that order in the data processing system shown in FIG. 10;

FIG. 15 is a view of the overall configuration of a data processing system according to a third embodiment of the present invention;

FIG. 16 is a view for explaining a scheduling buffer shown in FIG. 15;

FIG. 17 is a view for explaining a format of picture property data PP;

FIG. 18 is a view for explaining the change in state of a scheduling buffer 45_1 in the case of successively outputting a 2× speed change command and a 3× speed change command from 1× speed reproduction in the reproduction apparatus shown in FIG. 15;

FIG. 19 is a view for explaining the change in state of a scheduling buffer 45_1 in the case of successively outputting a 2× speed change command and a 1× speed change command from 3× speed reproduction in the reproduction apparatus shown in FIG. 15;

FIG. 20 is a flow chart for explaining an example of the operation of the data processing system shown in FIG. 15;

FIG. 21 is a flow chart following FIG. 20 for explaining an example of the operation of the data processing system shown in FIG. 15;

FIG. 22 is a flow chart following FIG. 21 for explaining an example of the operation of the data processing system shown in FIG. 15; and

FIG. 23 is a flow chart following FIG. 22 for explaining an example of the operation of the data processing system shown in FIG. 15.

### DESCRIPTION OF THE PREFERRED EMBODIMENTS

Below, data processing systems according to embodiments of the present invention will be explained.

### First Embodiment

In this embodiment, the case of the reproduction apparatus being provided with a plurality of decoders is shown.

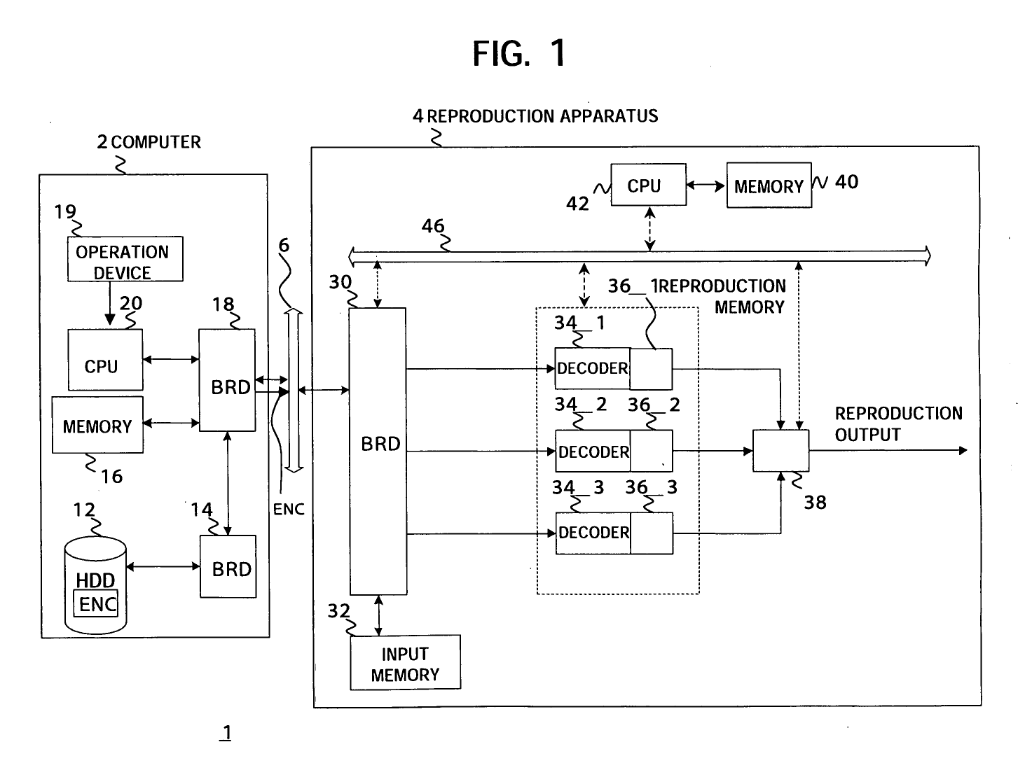

FIG. 1 is a view of the overall configuration of a data processing system 1 according to an embodiment of the present invention. As shown in FIG. 1, the data processing system 1, for example, has a computer 2 and a reproduction apparatus 4.

[Computer 2]

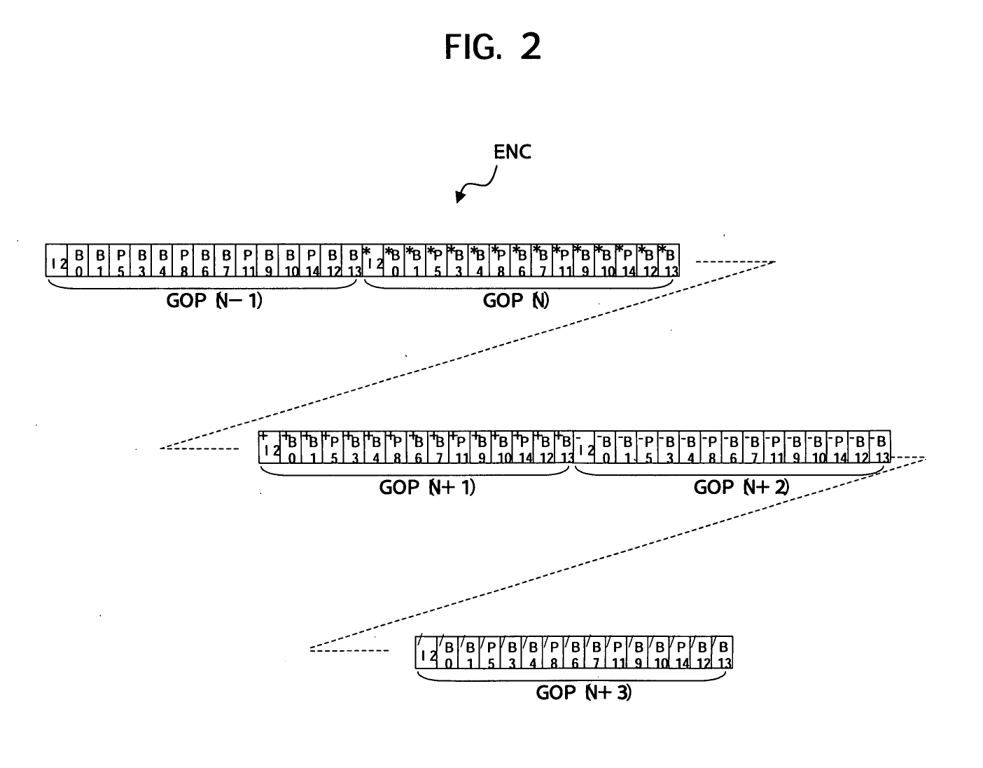

As shown in FIG. 1, the computer 2 has an HDD 12, a bridge 14, a memory 16, a bridge 18, operation device 19, and a CPU 20. The HDD 12 for example stores reproduced data ENC encoded by the MPEG scheme. The reproduced data ENC, as shown in FIG. 2, is comprised of a plurality of GOP (Groups Of Pictures) successively decoded at the reproduction apparatus 4. In the example shown in FIG. 2, it is decoded in the order of GOP(N−1), (N), (N+1), (N+2), and (N+3). Each GOP is comprised of I, P, and B picture data (frame data). Further, each GOP includes a single I picture data. In the present embodiment, for example, a so-called “long GOP” with a relatively large number of picture data in the GOP is used. Note that, in the drawings of this application, the picture data belonging to the GOP (N−1) is not given any symbol at the top left, the picture data belonging to the GOP (N) is given an asterisk at the top left, the picture data belonging to the GOP (N+1) is given a “+” at the top left, the picture data belonging to the GOP (N+2) is given a “−” at the top left, and the picture data belonging to the GOP (N+3) is given a “/” at the top left. Further, in the drawings, the numerals appended to the bottom rights of the “I”, “P”, and “B” show the order in which the decoding results of the picture data are reproduced and output.

The I picture data is picture data of an intra- (in-frame) encoded image and is decoded independently from other picture data. Further, the P picture data is picture data of the frame predictively encoded in the forward direction and is decoded with reference to the I or P picture data positioned time-wise in the past (previous display order). Note that the “I and P picture data” is also referred to as the “anchor picture data”. Further, the B picture data is picture data of the frame predictively encoded in two directions and is decoded while referring to the I or P picture data positioned time-wise in front or in back (display order in front or back). Note that the read rate of the HDD 12 is slower than the maximum reproduction rate of the reproduction apparatus 4.

The bridge 14 provides an expansion function of the bridge 18 and is provided with a PCI expansion slot or IDE (Integrated Drive Electronics) slot etc. The bridge 14 basically has the same functions as the bridge 18, but has a narrower bandwidth than the bridge 18 and has lower speed access devices than the devices connected to the bridge 18 connected to it.

The memory 16 is for example a semiconductor memory and stores the programs and data used for the processing by the CPU 20. The operation device 19 is a keyboard, mouse, or other operating means and outputs an operation signal corresponding to user operations to the CPU 20. The operation device 19 receives an operation for designating a reproduction point of the reproduced data ENC, an operation for issuing a reproduction start command of the designated reproduction point, and a transient command operation in accordance with user operations based on a not shown operation screen and outputs an operation signal showing the same to the CPU 20. The bridge 18 has the bridge 14, memory 16, PCI bus 6, and CPU 20 connected to it and converts data along with transfer through the CPU 20 address bus and data bus.

The CPU 20, for example, executes a program read from the memory 16 to control the operation of the computer 2. When the CPU 20 receives an operation signal from the operation device 19 indicating the operation for designating a reproduction point, it reads the GOP including the picture data of the designated reproduction point from the HDD 12 and outputs it through the bridge 18 and PCI bus 6 to the reproduction apparatus 4. Further, when the CPU 20 receives from the operation device 19 an operation signal indicating a reproduction start command, it outputs a reproduction start command including the designated reproduction point through the bridge 18 and PCI bus 6 to the reproduction apparatus 4. Further, when the CPU 20 receives from the operation device 19 an operation signal indicating a speed change command, it outputs a speed change command through the bridge 18 and PCI bus 6 to the reproduction apparatus 4. Further, when the CPU 20 receives from the operation device 19 an operation signal indicating a transient command operation, it outputs the transient command through the bridge 18 and PCI bus 6 to the reproduction apparatus 4. Further, the CPU 20 outputs the GOPs to the reproduction apparatus 4 so that, among the GOPs in the reproduced data ENC, the GOP one position in the display order before the GOP including the picture data of the reproduction point in the reproduction apparatus 4 and the GOP one position in display order after it are stored in the input memory 32 of the reproduction apparatus 4.

[Reproduction Apparatus 4]

As shown in FIG. 1, the reproduction apparatus 4, for example, has a PCI bridge 30, an input memory 32, decoders 34_1 to 34_3, reproduction memories 36_1 to 36_3, a selector 38, a control memory 40, a CPU 42, and a control bus 46. Note that the control memory 40 stores a predetermined program (program of the present invention) and that the CPU 42 reads and executes that program to perform the following processing. The predetermined program may be stored in a semiconductor memory or other control memory 40 or may be stored on an HDD, optical disk, or other storage medium.

The PCI bridge 30 is provided with a memory for buffering the GOPs and commands input via the PCI bus 6 from the computer 2. Further, the bridge 18 is provided with a dynamic memory access (DMA) transfer function.

“Input Memory 32”:

The input memory 32 is an SDRAM or other semiconductor memory and temporarily stores GOPs input via the PCI bridge 30.

“Decoders 34_{—}1, 34_{—}2, 34_{—}3”

The decoder 34_1, in accordance with the decode command input from the CPU 42 (control of CPU 42), receives as input the reproduced data ENC read from the input memory 32 through the PCI bridge 30, decodes it by the MPEG system, and writes the results into the reproduction memory 36_1. Specifically, the decoder 34_1, under the control of the CPU 42, decodes the I picture data read from the input memory 32 without referring to the decoding results of other picture data. Further, the decoder 34_1, under the control of the CPU 42, decodes the P picture data read from the input memory 32 by referring to the decoding results of the I or P picture data positioned time-wise in the past and already having decoding results stored in the respective reproduction memory 36_1.

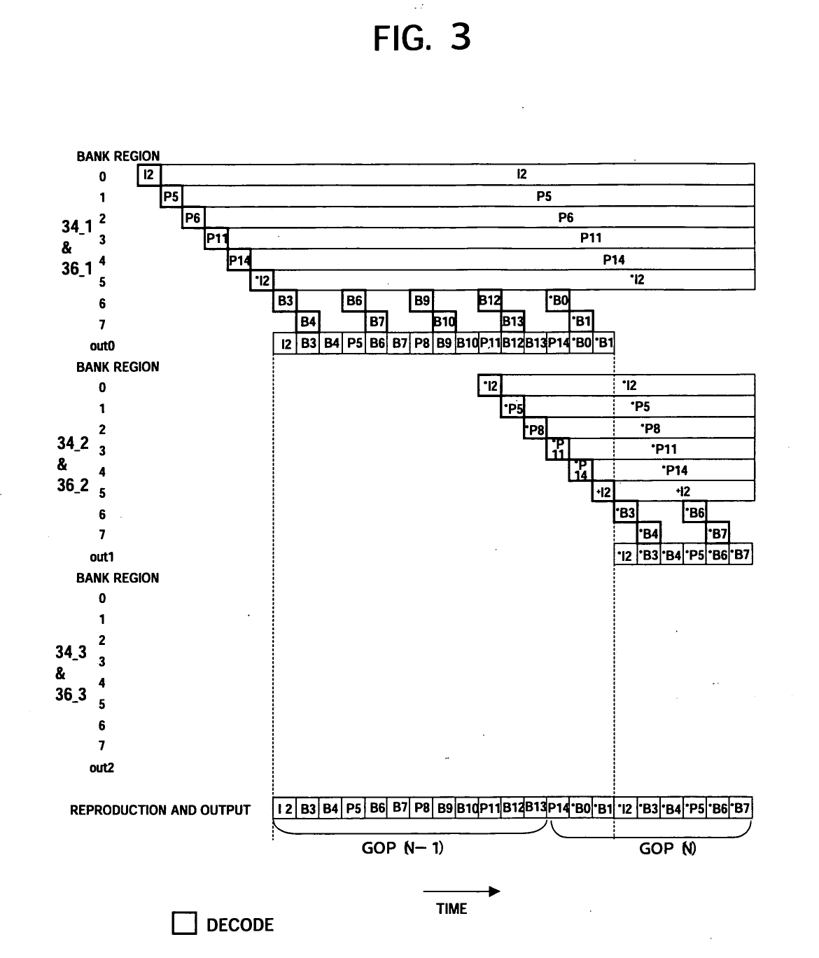

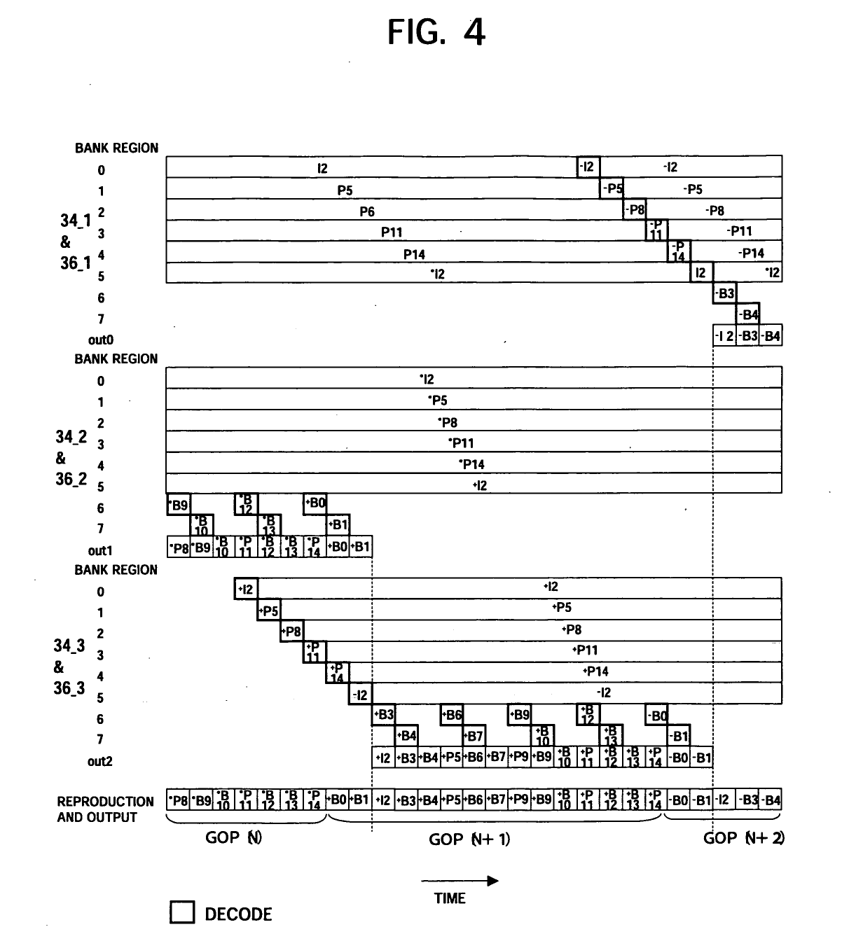

FIG. 3 and FIG. 4 are views of the decoding by the decoders 34_1, 34_2, and 34_3 when reproducing reproduced data ENC at 1× speed in the forward direction, the states of storage of the reproduction memories 36_1 to 36_3, and the production and output. In FIG. 3, FIG. 4, and the later explained drawings, the bank regions “0” to “7” shown linked with the decoder 34_1 are bank regions defined in the reproduction memory 36_1, the bank regions “0” to “7” shown linked with the decoder 34_2 are bank regions defined in the reproduction memory 36_2, and the bank regions “0” to “7” shown linked with the decoder 34_3 are bank regions defined in the reproduction memory 36_3. Further, “out0”, “out1”, and “out2” show decoding results output from the decoders 34_1, 34_2, and 34_3 to the selector 38. Further, the bottommost “reproduction and output” show reproduction and output from the selector 38. Further, in FIG. 3, FIG. 4, and the later explained drawings, parts shown surrounded by bold lines show the decoding by the decoders 34_1, 34_2, and 34_3.

As shown in FIG. 3 and FIG. 4, the decoder 34_1 holds in the reproduction memory 36_1 the storage of the decoding results of the I and P picture data no longer used for reproduction and output in the case of continuing reproduction in the reproduction direction designated from the CPU 42 in accordance with a decode command from the CPU 42. For example, the decoder 34_1 holds the decoding results of I2, P5, P8, P11, P14, *I2 even after finishing the reproduction and output of the GOP(N−1). Due to this, as explained below, when a speed change command occurs, it can perform reproduction and output right after the change in speed within one picture's worth of processing time by using the decoding results held in storage in the reproduction memory 36_1. That is, when a speed change command occurs, the decoder 34_1 can use the decoding results of the I and P picture data already stored in the reproduction memory 36_1 before the speed change command for the reproduction and output. Specifically, for the I and P picture data, the decoder 34_1 reads and reproduces and outputs the decoding results of the I and P picture data already stored in the reproduction memory 36_1 after a speed change command in accordance with a decode command from the CPU 42. Further, for the B picture data, the decoder 34_1 performs decoding referring to the decoding results of the I and P picture data forming anchor picture data of that B picture data already stored in the reproduction memory 36_1 after a speed change command in accordance with a decode command from the CPU 42 and reproduces and outputs the decoding results in accordance with a display command from the CPU 42.

Further, the decoder 34_1, as shown in FIG. 3, decodes the I and P picture data in the GOP being decoded before the B picture data in accordance with a decode command from the CPU 42 and writes the decoding results in the reproduction memory 36_1.

The decoders 34_2 and 34_3 have the same configurations as the decoder 34_1. They decode the image data input via the PCI bridge 30 by the MPEG scheme and write the results in their respective reproduction memories 36_2 and 36_3.

Below, the method of writing the decoding results in the reproduction memories 36_1, 36_2, and 36_3 by the decoders 34_1, 34_2, and 34_3 will be explained. As shown in FIG. 3 and FIG. 4, each of the reproduction memories 36_1, 36_2, and 36_3 has eight bank regions “0” to “7”. In this embodiment, as shown in FIG. 3 and FIG. 4, among the eight bank regions provided at each of the reproduction memories 36_1, 36_2, and 36_3, the six bank regions “0” to “5” are used fixed as storage regions for exclusively storing the decoding results of the I and P picture data and the two bank regions “6” and “7” are used fixed as storage regions for storing the decoding results of the B picture data. That is, the reproduction memories 36_1 to 36_3 simultaneously store the decoding results of all of the I and P picture data decoded at the respective decoders 34_1, 34_2, and 34_3. This storage is held until the decoders are written with the decoding results of the I and P picture data of the GOP to be next decoded.

When decoding the reproduced data ENC shown in FIG. 2, the decoder 34_1, for example as shown in FIG. 3, writes the I2, P5, P8, P11, and P14 picture data in the GOP(N−1) and the I2 picture data in the GOP(N) in the bank regions “0” to “5” in the reproduction memory 36_1. Further, the decoder 34_2, for example as shown in FIG. 3 and FIG. 4, writes the I2, P5, P8, P11, and P14 picture data in the GOP (N) and the I2 picture data in the GOP(N+1) in the bank regions “0” to “5” of the reproduction memory 36_2. Further, the decoder 34_3, for example as shown in FIG. 4, writes the I2, P5, P8, P11, and P14 picture data in the GOP (N+1) and the I2 picture data in the GOP(N+2) in the bank regions “0” to “5”, of the reproduction memory 36_3.

Further, the decoder 34_1, when decoding the B picture data in the GOP(N−1), refers to the decoding results of the I and P picture data stored in the bank regions “0” to “5” of the reproduction memory 36_1. Further, the decoder 34_2, when decoding the B picture data in the GOP (N), refers to the decoding results of the I and P picture data stored in the bank regions “0” to “5” of the reproduction memory 36_2. Further, the decoder 34_3, when decoding the B picture data in the GOP(N+1), refers to the decoding results of the I and P picture data stored in the bank regions “0” to “5” of the reproduction memory 36_3. Note that the decoders 34_1, 34_2, and 34_3 successively overwrite the decoding results of the B picture data which the banks “6” and “7” of the reproduction memories 36_1 to 36_3 store with the decoding results of the B picture data three pictures after that B picture data. Due to this, there is no need to provide banks regions corresponding to all of the B picture data in a GOP, and the reproduction memories 36_1 to 36_3 can be made small in size.

“Selector 38”:

The selector 38, under the control of the CPU 42, switches and selectively reproduces and outputs as the picture data S38 the picture data after decoding read from the reproduction memories 36_1, 36_2, and 36_3.

“CPU 42”:

The CPU 42 performs decoding scheduling for each GOP stored in the input memory 32 so as to decode the picture data included in that GOP in accordance with the designated reproduction rate. Specifically, the CPU 42 selects the picture data to be decoded in the picture data included in the GOP at the designated reproduction rate, determines the timing for decoding the head picture data in the selected picture data (for example, the I picture data) and the order for decoding the selected picture data, and generates decoding scheduling results showing the results. The CPU 42 determines whether to decode each picture data in units of picture data based on the above decoding scheduling results and the designated reproduction rate. When deciding to decode it, it issues a decode command for that picture data and makes the decoders 34_1, 34_2, and 34_3 perform the following decoding processing. Further, the CPU 42 determines whether to reproduce and output each picture data in units of picture data based on the above results of decoding scheduling and the designated reproduction rate. When deciding to reproduce and output it, it issues a display command of that picture data. Note that in this embodiment, even when some reproduction rate is designated, the CPU 42 decodes the I and P picture data in each GOP with priority over the B picture data. Therefore, after receiving a speed change command, the reproduction and output after the change in speed can obtain the decoding results for any of the I, P, and B picture data within the time for decoding one picture data, that is, the reproduction and output after the change in speed can be started in a short time.

The CPU 42 for example reads the picture data from the input memory 32 so that the I and P picture data belonging to the same GOP and the B picture data referring to the decoding results of the I and P picture data are decoded by the same decoders 34_1, 34_2, and 34_3. The CPU 42 for example reads out the I and P picture data in the GOP(N−1) and the B picture data in the GOP(N) decoded with reference to the decoding results of the I and P picture data through the PCI bridge 30 from the input memory 32 and outputs them to the decoder 34_1. Here, in the present embodiment, an open GOP decoded with reference to the decoding results of the I and P picture data of a GOP with different B picture data is referred to. Specifically, for example, the B0 and B1 picture data in the GOP(N) shown in FIG. 2 is decoded with reference to the decoding results of the I and P picture data in the GOP(N−1). Therefore, the CPU 42 outputs the B0 and B1 picture data in the GOP(N) to the decoder 34_1.

Further, CPU 42 reads for example the I and P picture data in the GOP(N) and the B picture data in the GOP(N+1) decoded referring to the decoding results of the I and P picture data through the PCI bridge 30 from the input memory 32 and outputs them to the decoder 34_2. Further, the CPU 42 reads for example the I and P picture data in the GOP(N+1) and the B picture data in the GOP(N+2) decoded referring to the decoding results of the I and P picture data through the PCI bridge 30 from the input memory 32 and outputs them to the decoder 34_3.

When the CPU 42 for example receives a reproduction start command from the CPU 20 of the computer 2, it makes the decoders 34_1, 34_2, and 34_3 decode the plurality of GOPs including the reproduction point. At this time, the CPU 42 controls the decoding of the B picture data by the decoders 34_1, 34_2, and 34_3, the reading from the reproduction memories 36_1, 36_2, and 36_3 to the selector 38, and the selection of the selector 38 so that data is reproduced and output from the reproduction point in the designated direction and at the designated speed.

Below, examples of the operation of the data processing system 1 shown in FIG. 1 will be explained.

[FIRST EXAMPLE OF OPERATION]

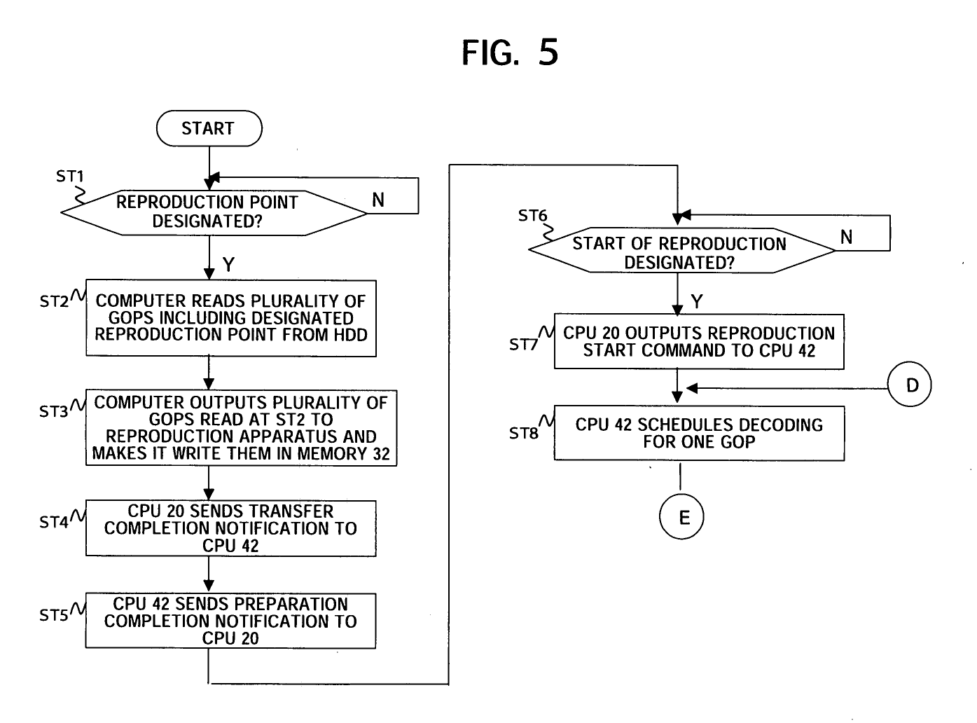

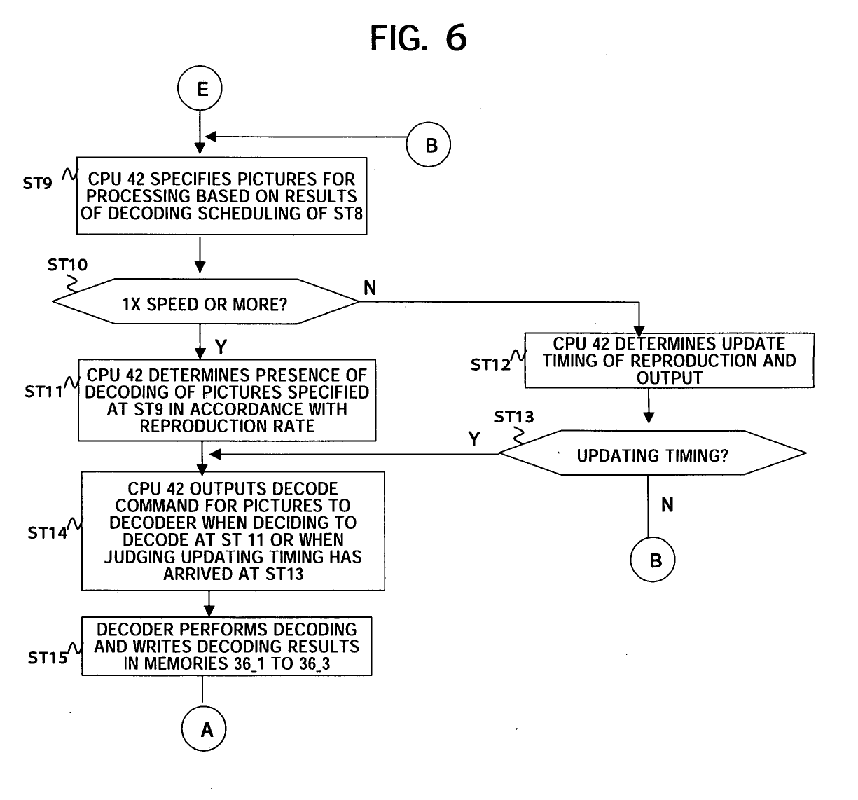

Below, an example of the operation from when the computer 2 designates the picture data for reproduction to when the reproduction apparatus 4 reproduces and outputs it will be explained. FIG. 5 and FIG. 6 are flow charts for explaining the example of operation.

Step ST1:

The CPU 20 of the computer 2 judges if an operation signal indicating an operation for designation of a reproduction point in the reproduced data ENC has been input from the operation device 19. It proceeds to step ST2 when judging it has been designated, while repeats the processing of step ST1 when judging it has not.

Step ST2:

The CPU 20 of the computer 2 reads from the HDD 12 the GOP including the picture data of the reproduction point designated at step ST1 and the surrounding GOPs or a total of three (plurality of) GOPs.

Step ST3:

The CPU 20 of the computer 2 outputs the plurality of GOPs read at step ST2 through the bridge 18 and PCI bus 6 to the reproduction apparatus 4. The CPU 42 of the reproduction apparatus 4 writes the GOPs input from the computer 2 through the PCI bridge 30 into the input memory 32.

Step ST4:

The CPU 20 of the computer 2 outputs a transfer completion notification to the CPU 42 of the reproduction apparatus 4. This transfer completion notification shows the identification data of the GOPs output (transferred) at step ST3 from the computer 2 to the reproduction apparatus 4, the addresses in the input memory 32 where the GOPs are written, and the sizes of the data of the GOPs. Further, the transfer completion notification shows the identification data of each picture data in the output GOP, the address in the input memory 32 where the picture data has been written, and the size of the picture data. The CPU 42 writes the transfer completion notification into the control memory 40.

Step ST5:

The CPU 42 of the reproduction apparatus 4, after finishing the processing of step ST4, outputs a preparation completion notification to the CPU 20 of the computer 2.

Step ST6:

The CPU 20 of the computer 2 judges if an operation signal indicating a reproduction start command operation designating a reproduction point has been input from the operation device 19. It proceeds to step ST7 when judging it has been input, while repeats the processing of step ST6 when judging it has not.

Step ST7:

When judging input, the CPU 20 of the computer 2 outputs a reproduction start command designating a reproduction point to the CPU 42 of the reproduction apparatus 4.

Step ST8

The CPU 42 of the reproduction apparatus 4 performs scheduling for determining the order of decoding the picture data in a GOP stored in the input memory 32 including picture data of a reproduction point indicated by the reproduction start command input at step ST7 in accordance with the relationship of inter-reference between the picture data and the reproduction direction.

Step ST9:

The CPU 42 of the reproduction apparatus 4 successively specifies the picture data for processing based on the results of the decoding scheduling of step ST8.

Step ST10:

The CPU 42 of the reproduction apparatus 4 judges if the designated reproduction rate is 1× speed or more. If judging it is 1× speed or more, it proceeds to step ST11, while if otherwise, it proceeds to step ST12.

Step ST11:

The CPU 42 of the reproduction apparatus 4 determines whether to decode the picture data specified at step ST10 based on the designated reproduction rate.

Step ST12:

The CPU 42 of the reproduction apparatus 4 determines whether the timing is timing for update of the reproduction and output based on the designated reproduction rate.

Step ST13:

When the CPU 42 of the reproduction apparatus 4 judges that the timing is the update timing at step ST12, it proceeds to step ST14.

Step ST14:

The CPU 42 of the reproduction apparatus 4 outputs a decode command of the picture data specified at step ST9 to any of the decoders 34_1, 34_2, and 34_3 when deciding on decoding at step ST11 or when judging an update timing at step ST13. Note that the CPU 42 does not output a decode command when the decoding results of the picture data specified at step ST9 are already stored in the reproduction memories 36_1, 36_2, and 36_3.

Step ST15:

The decoders 34_1, 34_2, and 34_3 of the reproduction apparatus 4 read the picture data indicated by the decode command input at step ST14 and write the decoding results to the reproduction memories 36_1 to 36_3.

Step ST16:

The CPU 42 of the reproduction apparatus 4 determines whether to reproduce and output the decoding results of the picture data specified at step ST9 based on the designated reproduction rate.

Step ST17:

The CPU 42 of the reproduction apparatus 4 outputs a display command designating the picture data to the corresponding decoders 34_1, 34_2, and 34_3 when deciding on reproduction and output at step ST16.

Step ST18:

The decoders 34_1, 34_2, and 34_3 of the reproduction apparatus 4 read the decoding results of the picture data designated by the display command from the reproduction memories 36_1, 36_2, and 36_3 based on the display command input at step ST17 and output them to the selector 38. Due to this, the decoding results of the designated picture data are reproduced and output

Step ST19:

The CPU 20 of the computer 2 judges if an operation signal indicating a transient command operation has been input from the operation device 19. When judges it has, it proceeds to step ST20, while if otherwise, it proceeds to step ST21.

Step ST20:

The CPU 20 of the computer 2 outputs the transient command (reproduction direction switching command) to the CPU 42 of the reproduction apparatus 4. After the transient command occurs, the CPU 20 and CPU 42 perform processing based on the switched reproduction direction. The reproduction apparatus 4 performs the processing of steps ST10 to ST19 in units of picture data.

Step ST21:

The CPU 20 and CPU 42 judge if the picture data processed at steps ST10 to ST19 is the last picture data in the GOP. If judging it is the last picture data, they proceed to step ST22, while if otherwise, they return to step ST9 and perform processing for the next picture data.

Step ST22:

The CPU 20 and CPU 42 judge if the processed picture data is the last GOP in the reproduced data ENC it belongs to. If judging that it is the last GOP, they end the processing, while if otherwise, they proceed to step ST23.

Step ST23:

The CPU 20 of the computer 2 reads the next GOP from the HDD 12 in accordance with the reproduction direction.

Step ST24:

The CPU 20 of the computer 2 outputs the plurality of GOPs read at step ST23 through the bridge 18 and PCI bus 6 to the reproduction apparatus 4. The CPU 42 of the reproduction apparatus 4 writes the GOP input from the computer 2 through the PCI bridge 30 into the input memory 32.

Step ST25:

The CPU 20 of the computer 2 outputs the transfer completion notification of the GOP output at step ST24 to the CPU 42 of the reproduction apparatus 4. The CPU 42 writes the transfer completion notification in the control memory 40.

Step ST26:

The CPU 42 of the reproduction apparatus 4, after ending the processing at step ST25, outputs a preparation completion notification to the CPU 20 of the computer 2.

Step ST27:

The CPU 42 of the reproduction apparatus 4, for example, judges if the scheduling of the GOP including the picture data of a reproduction point next in accordance with the reproduction direction has been completed or not (that is, if scheduling is required). When judging that scheduling has not been completed, it proceeds to step ST8, while when judging it has, it proceeds to step ST9.

[SECOND EXAMPLE OF OPERATION]

In this example of operation, the decoding of step ST15 shown in FIG. 6 will be explained in detail. The CPU 42 of the reproduction apparatus 4, based on the results of the above scheduling, for example, as explained using FIG. 3 and FIG. 4, reads the picture data included in the GOP stored in the input memory 32 and outputs it to the decoders 34_1, 34_2, and 34_3. Further, the decoders 34_1, 34_2, and 34_3, as explained above, decode this and write the decoding results in the reproduction memories 36_1, 36_2, and 36_3.

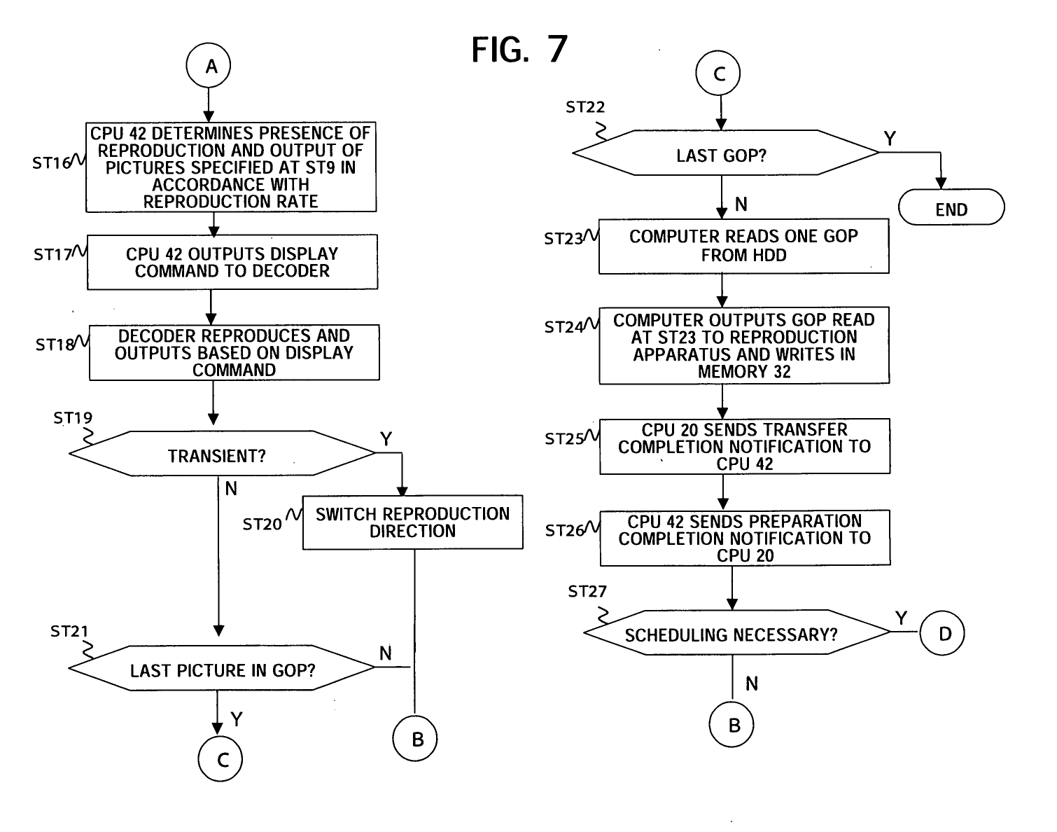

The reproduction apparatus 4, as shown in FIG. 3 and FIG. 4, first decodes the I and P picture data in the GOP before the B picture data in the decoders 34_1, 34_2, and 34_3 and writes the results in fixed bank regions in the reproduction memories 36_1, 36_2, and 36_3. Due to this, if there is time for decoding one picture's worth (one frame's worth) of data after this writing, it is possible to reproduce and output any picture data in the GOP being processed. That is, as explained later, when a command for change of the reproduction rate occurs right in the middle of decoding and reproducing and outputting the picture data in a GOP, it is possible to use the processing of steps ST9 to ST18 shown in FIG. 6 and FIG. 7 to reproduce and output picture data by the changed reproduction rate within the time for decoding 1 picture data after the speed change command. For example, when decoding and reproducing and outputting the B9 picture data in the GOP(N−1) shown in FIG. 3, the decoding results of the P8 and P11 picture data in the GOP(N−1) are necessary. Further, decoding of the P8 picture data requires the decoding results of the P5 picture data, while decoding of the P5 picture data requires the decoding results of the I2 picture data. Therefore, decoding the B9 picture data requires the decoding results of the I2, P5, P8, and P11 picture data. According to the reproduction apparatus 4, as shown in FIG. 3, by storing the I and P picture data in the reproduction memory 36_1, if the decoder 34_1 receives the B9 picture data of the GOP(N−1), the decoder 34_1 can use the P8 and P11 picture data already stored in the bank regions “2” and “3” of the reproduction memory 36−1 to immediately decode and reproduce and output the B9 picture data of the GOP(N−1). Due to this, change of the reproduction rate with no time lag is possible.

[THIRD EXAMPLE OF OPERATION]

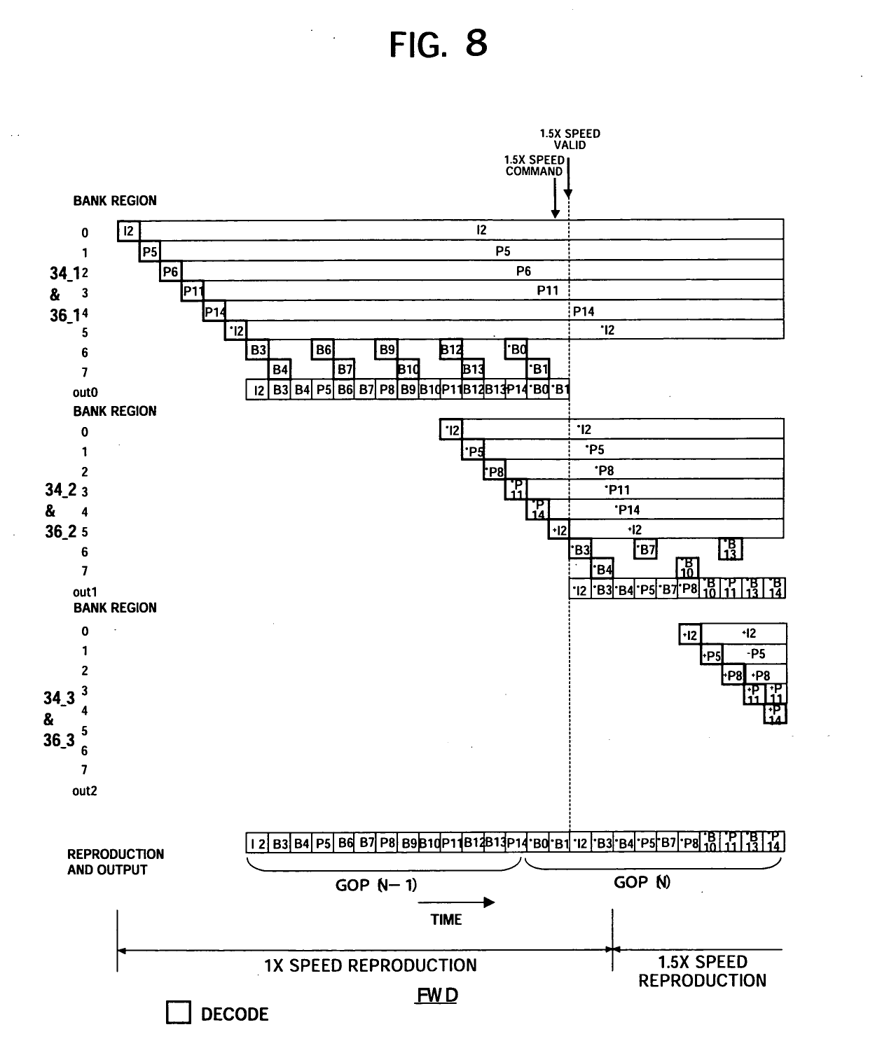

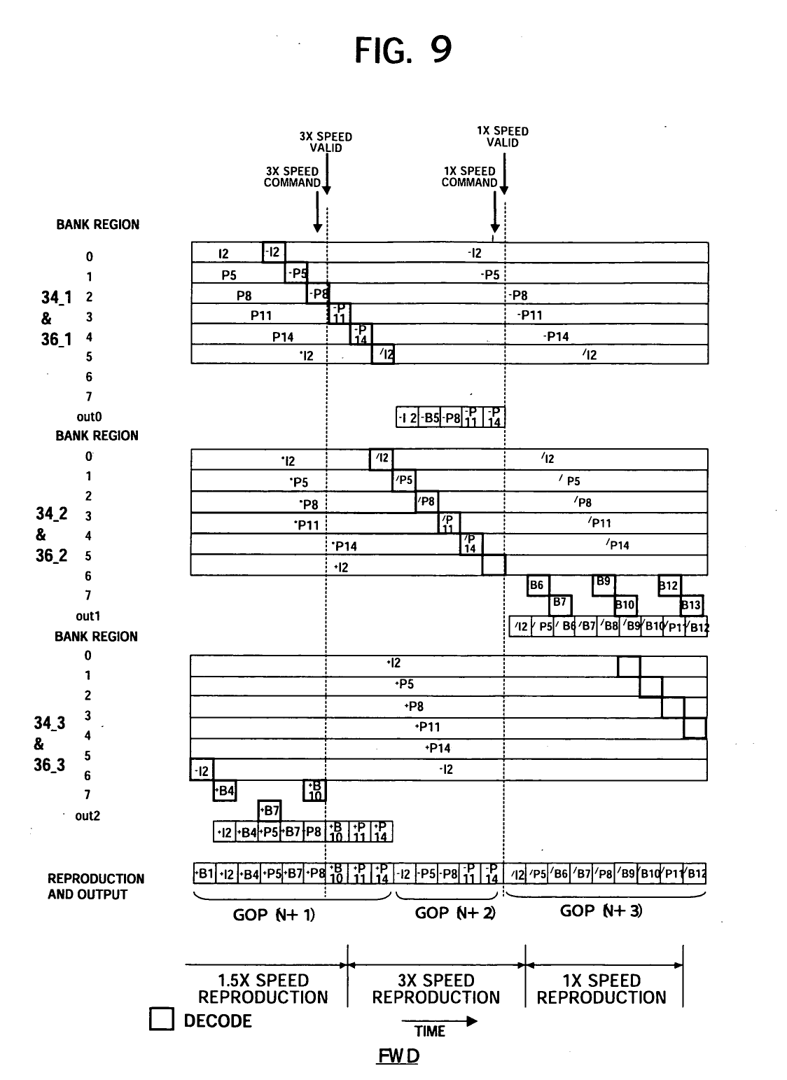

Below, an example of the operation of the reproduction apparatus 4 when engaged in the forward (FWD) 1× speed reproduction shown in FIG. 3 and FIG. 4 and changed in reproduction rate in the order of 1.5× speed reproduction, 3× speed reproduction, and 1× speed reproduction will be explained. FIG. 8 and FIG. 9 are views for explaining this example of operation. As shown in FIG. 8, while the decoder 34_2 is reproducing and outputting the decoding results of the B1 picture data of the GOP(N), if a command for change to 1.5× speed is received by the CPU 42 of the reproduction apparatus 4, the CPU 42 proceeds through steps ST9 to ST18 shown in FIG. 6 and FIG. 7 to perform decoding and reproduction and output corresponding to 1.5× speed before completing decoding and reproduction and output of the GOP(N). Due to this, it is possible to shift from reproduction and output of B4 picture data of the GOP(N) to 1.5× speed. That is, the reproduction apparatus 4 can realize 1.5× speed if not reproducing and outputting the B0, B3, B6, and B9 picture data in the results of decoding scheduling decoded as 1× speed reproduction, so by invalidating and compressing time wise the not reproduced and output picture data from the timing where the command for change to 1.5× speed becomes valid, 1.5× speed can be simply realized. At this time, the reproduction apparatus 4 decodes the anchor picture data constituted by the I and P picture data in the same way as 1× speed reproduction, writes it in the reproduction memories 36_1, 36_2, and 36_3, and decodes the B picture data invalidated and compressed time wise by the decoders 34_1, 34_2, and 34_3.

After this, as shown in FIG. 9, while the decoder 34_3 is reproducing and outputting the decoding results of the P8 picture data of the GOP(N+1), if a command for changing to 3× speed is received by the CPU 42 of the reproduction apparatus 4, the CPU 42 proceeds through steps ST9 to ST18 shown in FIG. 6 and FIG. 7 to perform decoding and reproduction and output corresponding to 3× speed before completing the decoding and reproduction and output of the GOP(N+1). Due to this, it is possible to shift from reproduction and output of the P11 picture data of the GOP(N+1) to 3× speed reproduction and output.

After this, as shown in FIG. 9, while the decoder 34_2 is reproducing and outputting the decoding results of the P14 picture data of the GOP(N+2), if a command for change to 1× speed is received by the CPU 42 of the reproduction apparatus 4, the CPU 42 proceeds through steps ST9 to ST18 shown in FIG. 6 and FIG. 7 to perform decoding and reproduction and output corresponding to 1× speed from the P5 picture data of the GOP(N+3). At this time, since the decoding results of the I and P picture data of the GOP(N+3) are stored in the reproduction memory 36_3, it is possible to shift from 3× speed reproduction to 1× speed reproduction in a short time. In this way, the reproduction apparatus 4 for example determines in advance the decode order in 1× speed reproduction by the decoding scheduling, judges the validity of the picture data with the decoder order shown in the decoding scheduling when the reproduction rate is designated (changed), and decodes only the picture data judged as valid so can perform variable speed reproduction with a good response.

As explained above, the data processing system 1, as explained using FIG. 6 and FIG. 7, performs decoding scheduling in units of GOPs. At the time of actually decoding and reproducing and outputting the picture data forming a GOP, it determines whether or not to decode and to reproduce and output the picture data scheduled for decoding in units of picture data based on the results of the decoding scheduling and the reproduction rate. Therefore, according to the data processing system 1, if a command for change of the reproduction rate occurs during reproduction of a GOP, it is possible to perform decoding and reproduction and output corresponding to the changed reproduction rate in units of picture data before completion of reproduction of the GOP. As a result, it is possible to shorten, compared with the past, the time from when the reproduction apparatus 4 receives a command for change of the reproduction rate to when reproduction and output corresponding to the changed reproduction rate are actually performed.

Further, in the data processing system 1, the reproduction apparatus 4 writes the decoding results of the I and P picture data before the B picture data in fixed bank regions of the reproduction memories 36_1 to 36_3 and continuously holds the same. Therefore, the reproduction apparatus 4 can reproduce and output all of the picture data in the GOP being processed during the period of decoding the B picture data. Further, the reproduction apparatus 4 successively overwrites the decoding results of the B picture data at fixed banks of the reproduction memories 36_1, 36_2, and 36_3. Due to this, it is possible to perform reproduction and output corresponding to the changed reproduction rate in a short time without greatly increasing the storage capacities of the reproduction memories 36_1 to 36_3.

The above effect is particularly remarkable when the picture data is of a high definition (HD) image or other image with a large amount of data or when employing a long GOP with a greater number of picture data in each GOP compared with a usual GOP.

### Second Embodiment

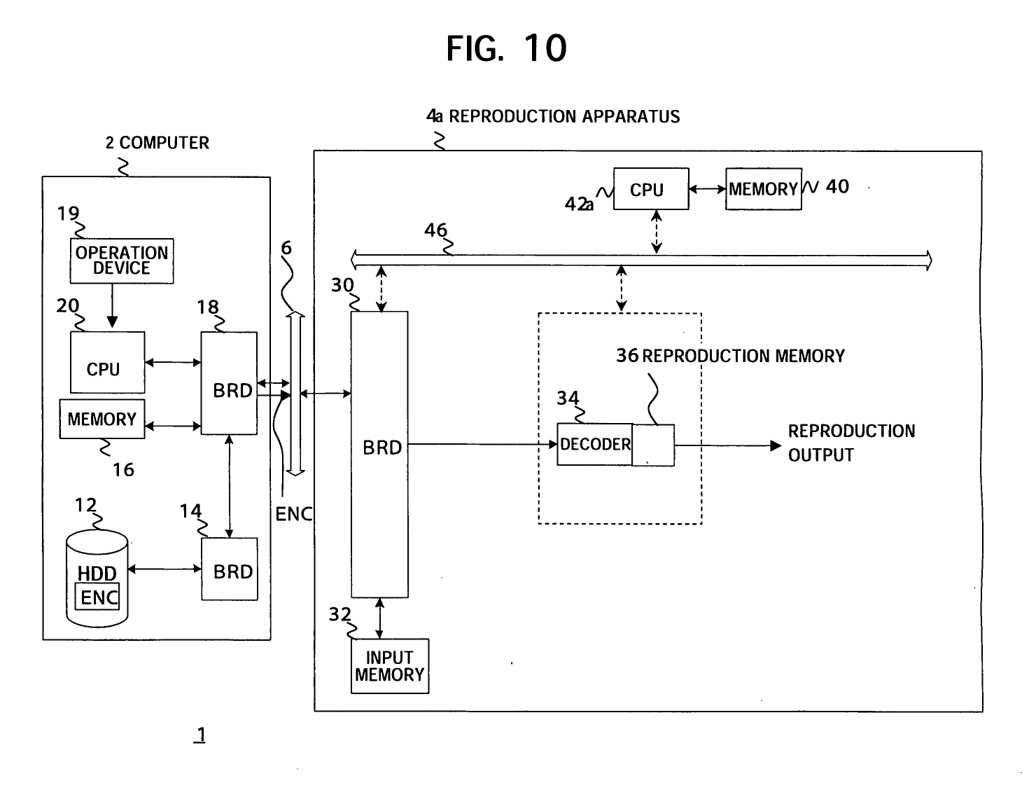

In this embodiment, the case where the reproduction apparatus is provided with a single decoder is illustrated. FIG. 10 is a view of the overall configuration of a data processing system 1a according to an embodiment of the present invention. As shown in FIG. 10, the data processing system 1a for example has a computer 2 and reproduction apparatus 4a. The computer 2 shown in FIG. 10 is the same as the computer 2 of the first embodiment. As shown in FIG. 10, the reproduction apparatus 4a has for example a PCI bridge 30, input memory 32, decoder 34, reproduction memory 36, control memory 40, CPU 42a, and control bus 46. In the configuration of the reproduction apparatus 4a shown in FIG. 10, components assigned the same reference numerals as in FIG. 1 are similar to those of the first embodiment. The reproduction apparatus 4a has a single decoder 34 and reproduction memory 36. In accordance with this, the CPU 42a controls the decoding and the reproduction and output of the picture data. Note that the processing of the reproduction apparatus 4a is the same as the processing of the reproduction apparatus 4 of the first embodiment of FIG. 5 to FIG. 7 except for the point of the decoding and the reproduction and output of the single decoder 34.

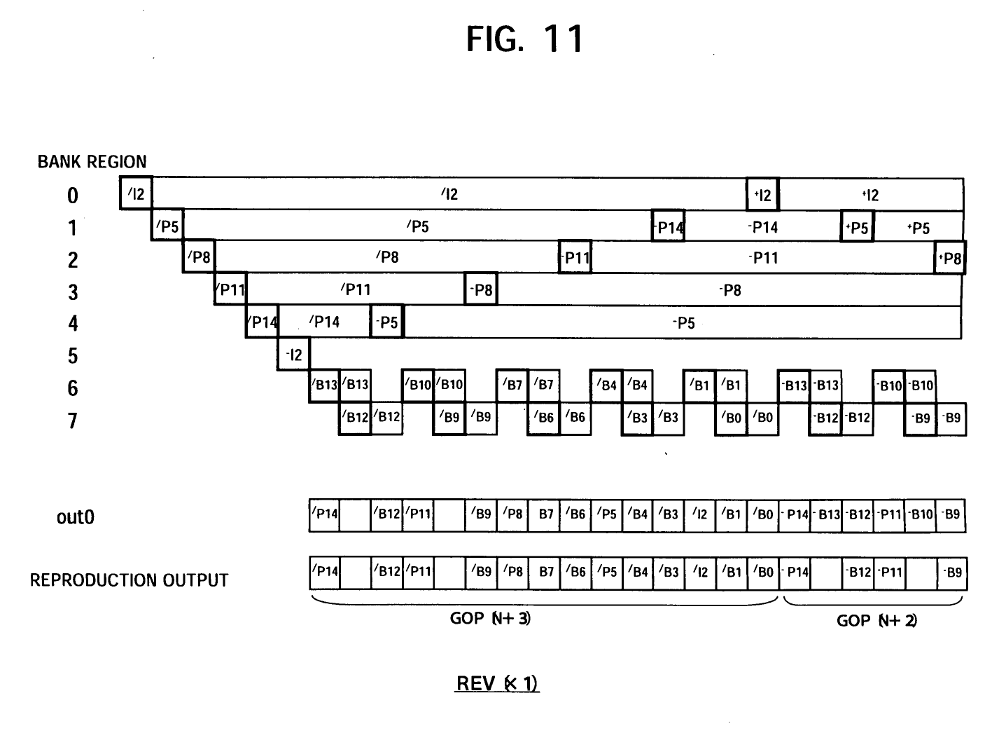

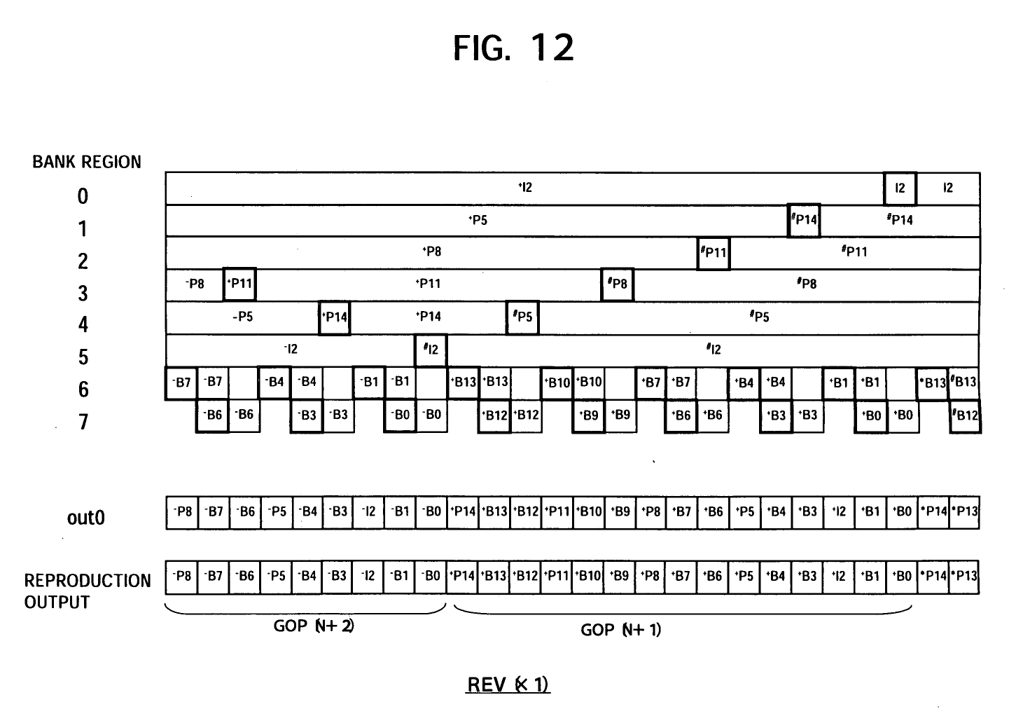

Below, the case where the data processing system la performs 1× speed reverse (REV) reproduction will be explained. FIG. 11 and FIG. 12 are views for explaining the operation where the data processing system 1a shown in FIG. 10 reproduces the reproduced data ENC in the reverse (REV) direction. As shown in FIG. 11 and FIG. 12, the decoder 34 first, in the case of reverse reproduction, decodes the I and P picture data of the GOP(N+3) and the I2 picture data of the GOP(N+2) and writes the decoding results in the bank regions “0” to “5” of the decoder 34. After this, the decoder 34 successively decodes the B13 and B12 picture data of the GOP(N+3), the P5 picture data of the GOP(N+2), the B10 and B9 picture data of the GOP(N+3), and the P8 picture data of the GOP(N+2). Further, the decoder 34 successively reproduces and outputs the decoding results of P14, B13, B12, P11, P10, B9, . . . of the GOP(N+3).

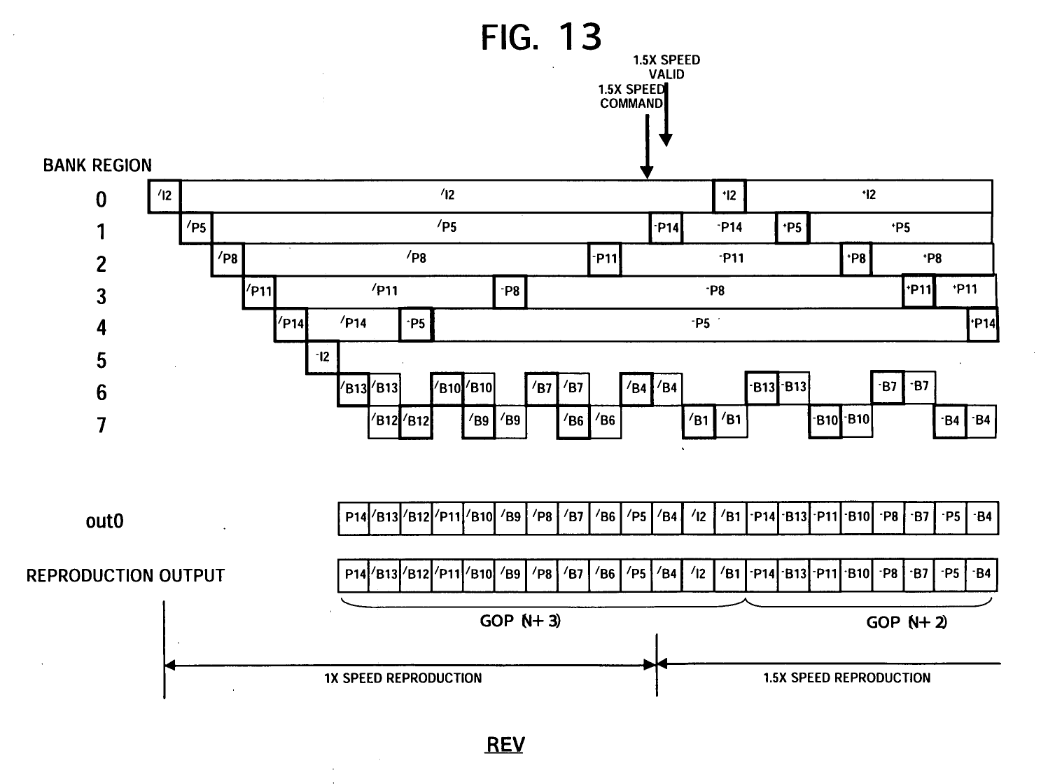

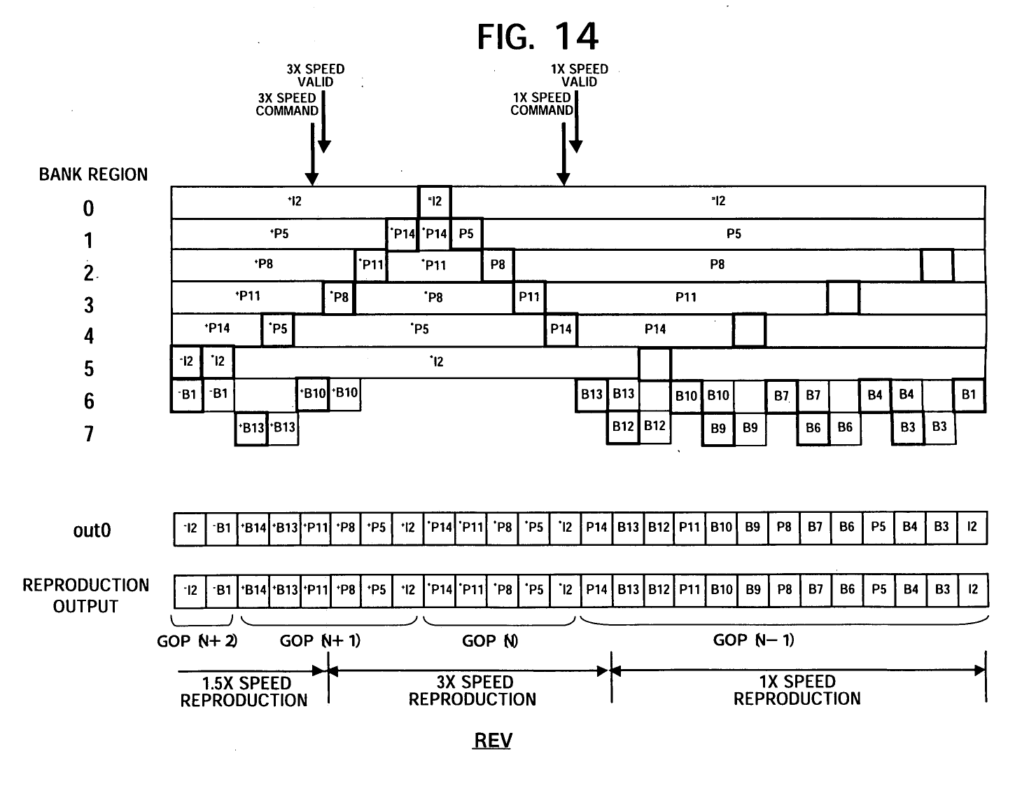

Below, the case of successively changing the reproduction rate from the 1× speed reverse reproduction shown in FIG. 11 to 1.5× speed reverse reproduction, 3× speed reverse reproduction, and 1× speed reverse reproduction will be explained. FIG. 13 and FIG. 14 are views for explaining examples of operation. As shown in FIG. 13, while the decoder 34 is reproducing and outputting decoding results of P5 picture data of the GOP(N+3) by 1× speed reverse reproduction, if a command for change to 1.5× speed reverse reproduction is received by the CPU 42 of the reproduction apparatus 4, the CPU 42 proceeds through steps ST9 to ST18 shown in FIG. 6 and FIG. 7 to perform decoding and reproduction and output corresponding to 1.5× speed before completing the decoding and reproduction and output of the GOP(N+3). Due to this, it is possible to shift from reproduction and output of the B4 picture data of the GOP(N+3) to reproduction and output of 1.5× speed reverse reproduction.

After this, as shown in FIG. 14, while the decoder 34 is reproducing and outputting decoding results of the P11 picture data of the GOP(N+1), if a command for change to 3× speed reverse reproduction is received by the CPU 42 of the reproduction apparatus 4, the CPU 42 proceeds through steps ST9 to ST18 shown in FIG. 6 and FIG. 7 to perform decoding and reproduction and output corresponding to 3× speed reverse reproduction before completing decoding and reproduction and output of the GOP(N+1). Due to this, it is possible to shift from reproduction and output of the P8 picture data of the GOP(N+1) to reproduction and output of 3× speed reverse reproduction.

After this, as shown in FIG. 14, while the decoder 34 is reproducing and outputting decoding results of the I2 picture data of the GOP(N), if a command for change to 1× speed reverse reproduction is received by the CPU 42 of the reproduction apparatus 4, the CPU 42 proceeds through steps ST9 to ST18 shown in FIG. 6 and FIG. 7 to perform decoding and reproduction and output corresponding to 1× speed reverse reproduction from the B13 picture data of the GOP(N−1). At this time, since the decoding results of the I and P picture data of the GOP(N+3) are stored in the reproduction memory 36, it is possible to shift from 3× speed reverse reproduction to 1× speed reverse reproduction in a short time. In this way, in the reproduction apparatus 4a, for example, the decode order in 1× speed reverse reproduction is determined in advance by decoding scheduling. When the reverse reproduction rate is designated (changed), the validity of the picture data with a decode order shown in the decoding scheduling is judged. Only picture data judged valid is decoded. By this, variable speed reproduction is possible even in reverse reproduction with a good response. By this data processing system 1a as well, effects similar to the data processing system 1 of the first embodiment.

### Third Embodiment

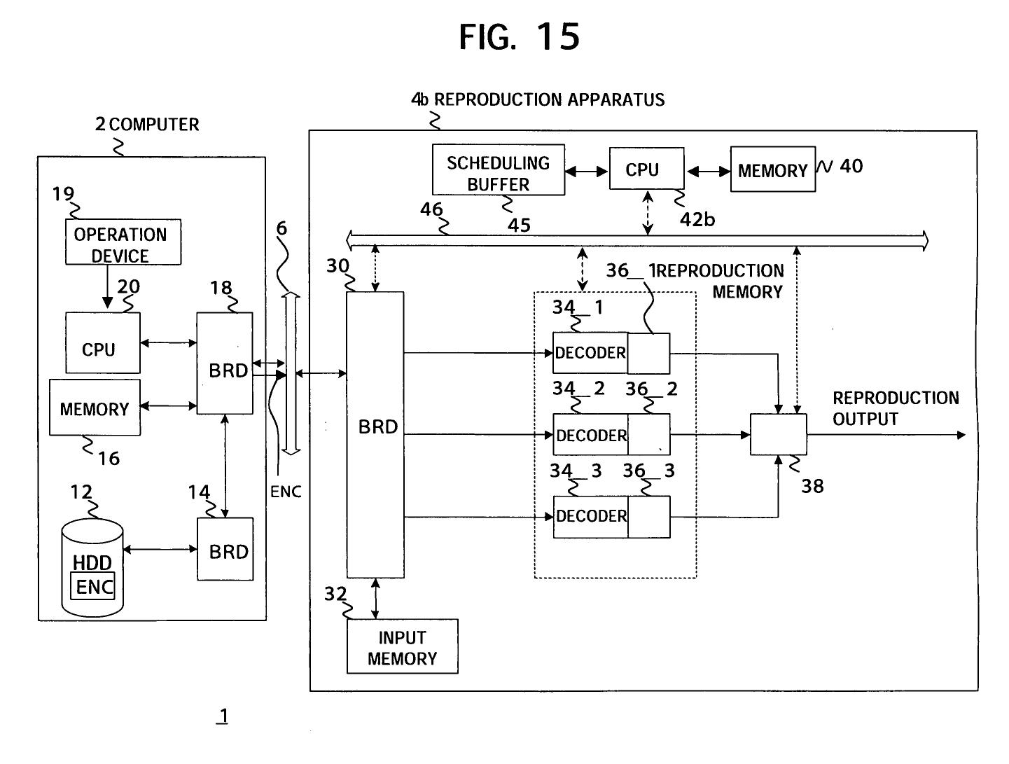

In this embodiment, the case of the system explained in the first embodiment wherein the picture property data PP indicating whether or not to decode the picture data is scheduled and stored at the scheduling buffer and where decoding is performed based on the same will be explained. FIG. 15 is a view of the overall configuration of the data processing system 1b according to an embodiment of the present invention. As shown in FIG. 15, the data processing system 1b for example has a computer 2 and reproduction apparatus 4b. The computer 2 shown in FIG. 15 is the same as the computer 2 of the first embodiment. As shown in FIG. 15, the reproduction apparatus 4b for example has a PCI bridge 30, input memory 32, decoder 34, reproduction memory 36, control memory 40, CPU 42b, scheduling buffer 45, and control bus 46. In the configuration of the reproduction apparatus 4b shown in FIG. 15, components assigned reference numerals the same as in FIG. 1 are similar to those in the first embodiment.

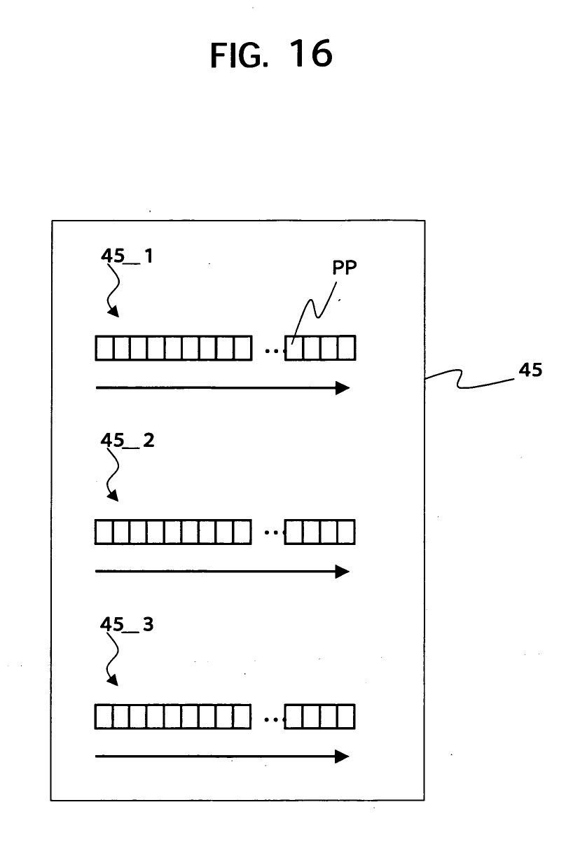

FIG. 16 is a view for explaining the scheduling buffer 45 shown in FIG. 15. As shown in FIG. 16, the scheduling buffer 45 has scheduling buffers 45_1 to 45_3. The scheduling buffer 45_1 is used for managing the picture data to be decoded at the decoder 34_1 shown in FIG. 15 and at 1× speed reproduction enables the picture property data PP of the picture data scheduled at the decoder 34_1 to be read out in the decode order. The scheduling buffer 45_2 is used for managing the picture data to be decoded at the decoder 34_2 shown in FIG. 15 and at 1× speed reproduction enables the picture property data PP of the picture data scheduled at the decoder 34_2 to be read out in the decode order. The scheduling buffer 45_3 is used for managing the picture data to be decoded at the decoder 34_3 shown in FIG. 15 and at 1× speed reproduction enables the picture property data PP of the picture data scheduled at the decoder 34_3 to be read out in the decode order.

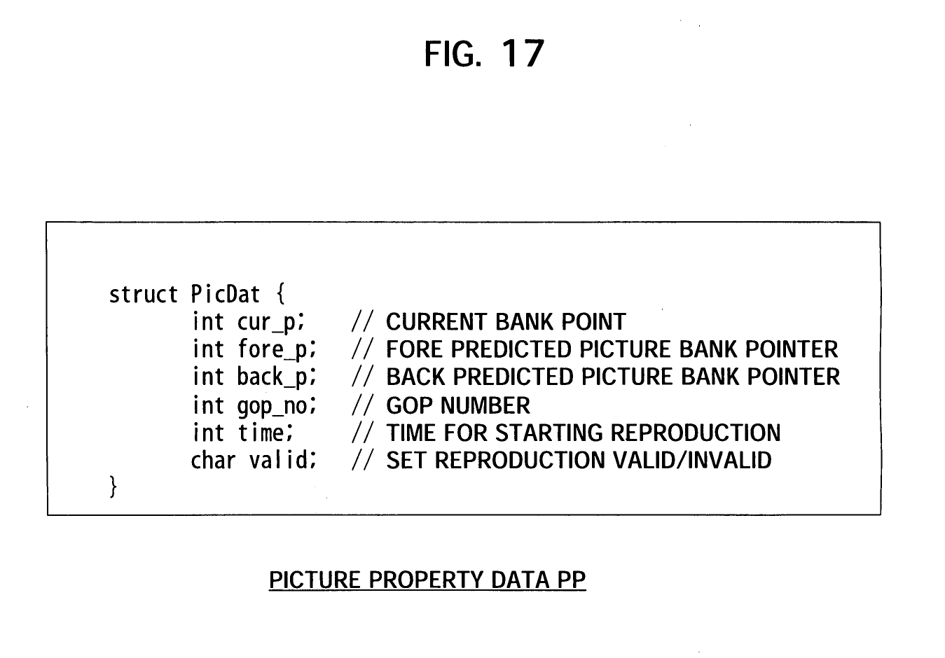

FIG. 17 is a view for explaining the format of picture property data PP. As shown in FIG. 17, the picture property data PP includes pointer data (cur_p) to banks of the reproduction memories 36_1 to 36_3 writing the decoding results of the corresponding picture data, pointer data (fore_p) to banks of the reproduction memories 36_1 to 36_3 storing the forward predictive pictures (picture data) used for decoding of the same, pointer data (back_p) to banks of the reproduction memories 36_1 to 36_3 storing the back predictive pictures (picture data) used for decoding of the same, the number of the GOP being decoding, the time for starting the decoding (reproduction) (“time”), and validity flag data (“valid”) showing the validity of the decoding.

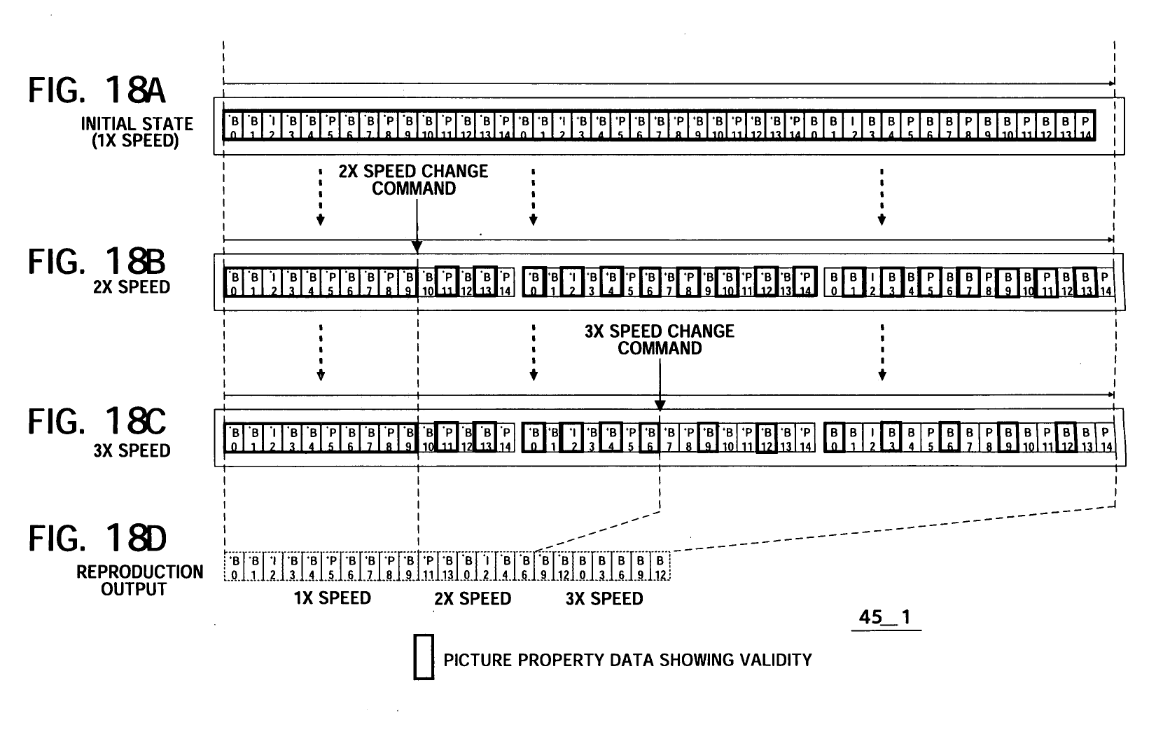

FIG. 18 is a view for explaining the change in state of the scheduling buffer 45_1 in the case of successively outputting a command for change to 2× speed and a command for change to 3× speed from 1× speed reproduction. As shown in FIG. 18A, the CPU 42b of the reproduction apparatus 4b in its initial setting sets valid the validity flag data “valid” of all of the picture property data stored in the scheduling buffer 45_1. After this, when the CPU 42b receives a command for change to 2× speed in accordance with a user operation, as shown in FIG. 18B, it sets valid every other validity flag data “valid” of the picture property data PP scheduled after the picture property data PP of the picture data being reproduced. After this, when the CPU 42b receives a command for change to 3× speed in accordance with a user operation, as shown in FIG. 18C, it sets invalid the validity flag data “valid” of the picture property data PP scheduled after the picture property data PP of the picture data being reproduced after every two data.

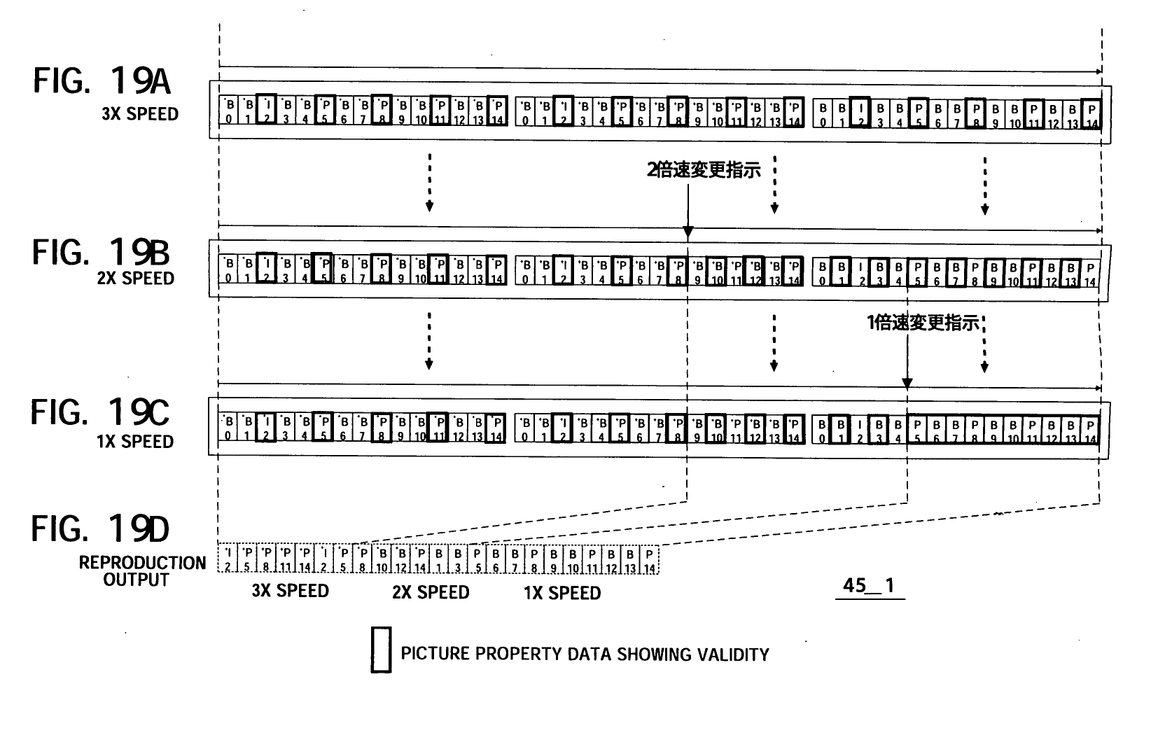

FIG. 19 is a view for explaining the change in state of the scheduling buffer 45_1 in the case of successively outputting a command for change to 2× speed and a command for change to 1× speed from 3× speed reproduction. As shown in FIG. 19A, in 3× speed reproduction, the validity flag data “valid” of the picture property data PP stored in the scheduling buffer 45_1 is made valid every other two data. After this, when the CPU 42b receives a command for changing to 2× speed in accordance with a user operation, as shown in FIG. 19B, it sets the validity flag data “valid” of the picture property data PP scheduled for after the picture property data PP of the picture data being reproduced to valid for every other data. After this, when the CPU 42b receives a 1× speed change command in accordance with a user operation, as shown in FIG. 19C, it sets as valid all of the validity flag data “valid” of the picture property data PP scheduled for after the picture property data PP of the picture data being reproduced.

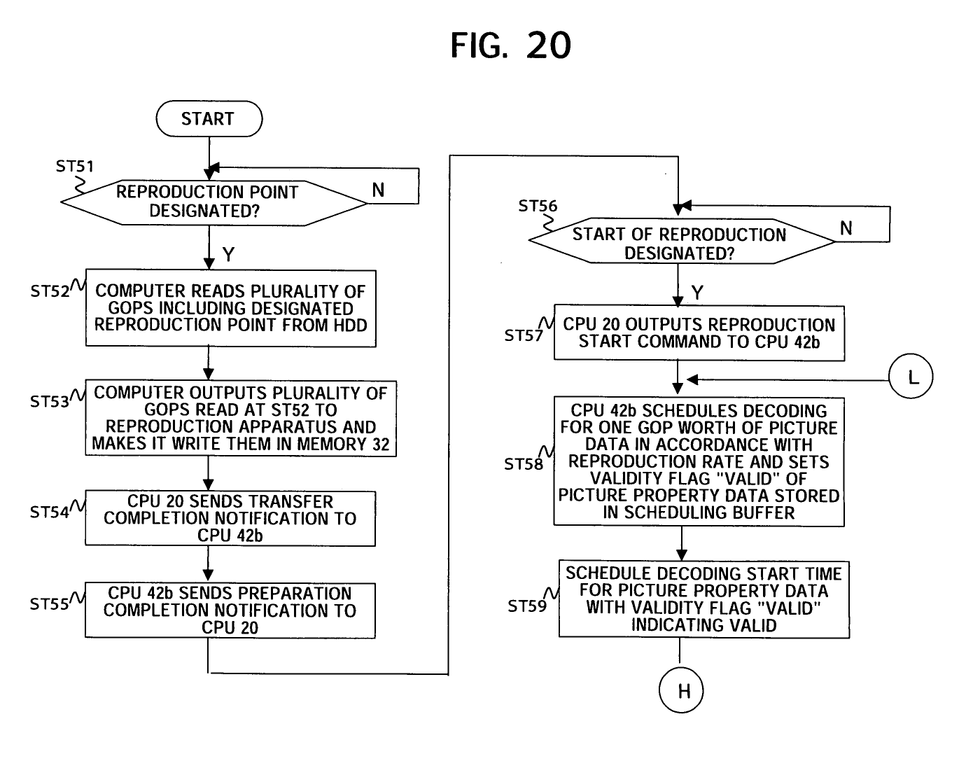

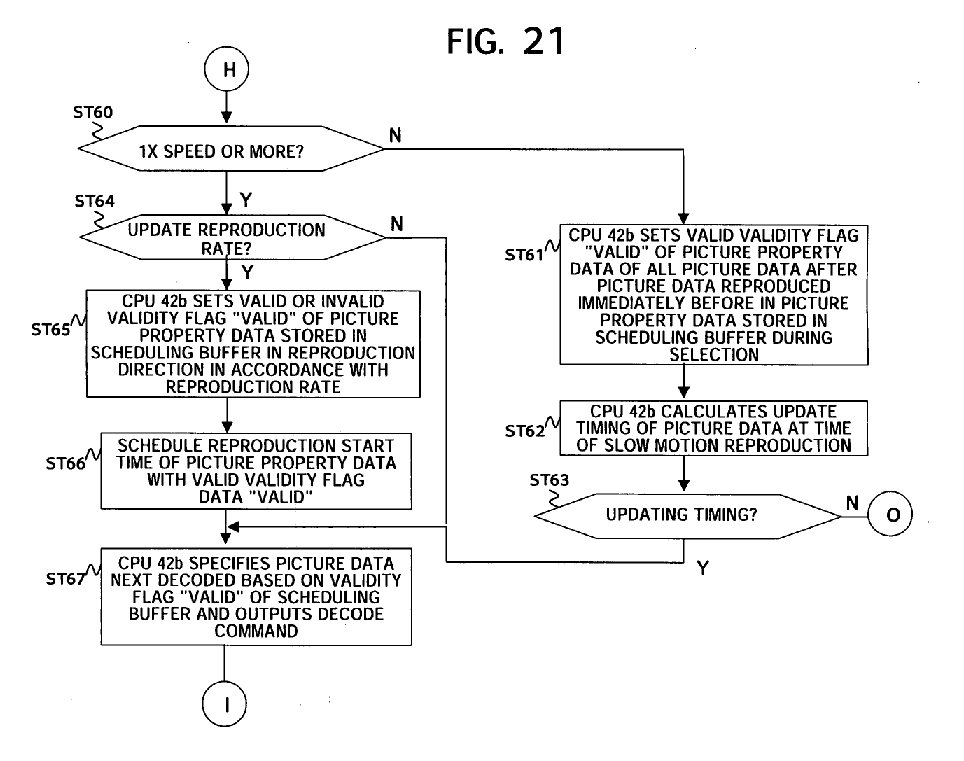

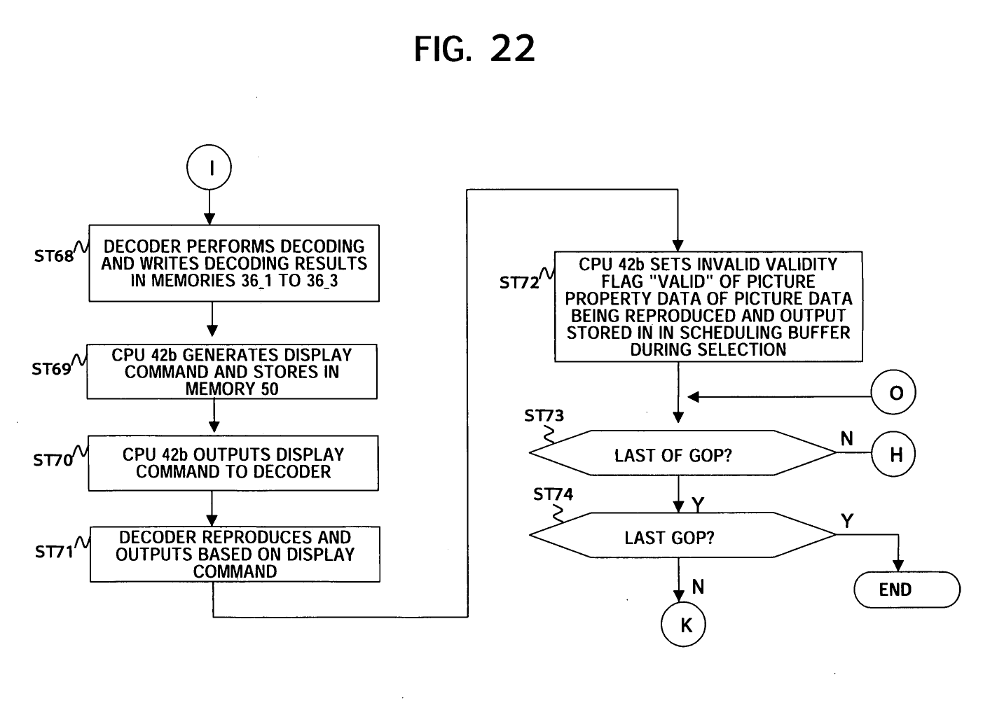

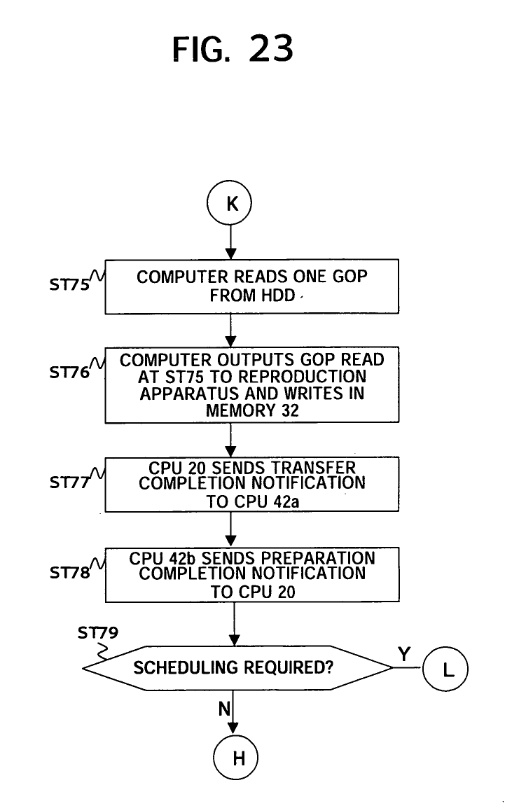

Below, an example of operation of the data processing system 1b shown in FIG. 15 will be explained. FIG. 20 to FIG. 23 are flow charts for explaining the example of operation of the data processing system 1b shown in FIG. 15.

Step ST51:

The CPU 20 of the computer 2 judges if an operation signal indicating an operation for designation of a reproduction point in the reproduced data ENC has been input from the operation device 19. It proceeds to step ST52 when judging it has been designated, while repeats the processing of step ST51 when judging it has not.

Step ST52:

The CPU 20 of the computer 2 reads from the HDD 12 the GOP including the picture data of the reproduction point designated at step ST51 and the surrounding GOPs or a total of three (plurality of) GOPs.

Step ST53:

The CPU 20 of the computer 2 outputs the plurality of GOPs read at step ST52 through the bridge 18 and PCI bus 6 to the reproduction apparatus 4b. The CPU 42 of the reproduction apparatus 4b writes the GOPs input from the computer 2 through the PCI bridge 30 into the input memory 32.

Step ST54:

The CPU 20 of the computer 2 outputs a transfer completion notification to the CPU 42b of the reproduction apparatus 4b. This transfer completion notification shows the identification data of the GOPs output (transferred) at step ST53 from the computer 2 to the reproduction apparatus 4b, the addresses in the input memory 32 where the GOPs are written, and the sizes of the data of the GOPs. Further, the transfer completion notification shows the identification data of each picture data in the output GOP, the address in the input memory 32 where the picture data has been written, and the size of the picture data. The CPU 42b writes the transfer completion notification into the control memory 40.

Step ST55:

The CPU 42a of the reproduction apparatus 4b, after finishing the processing of step ST54, outputs a preparation completion notification to the CPU 20 of the computer 2.

Step ST56:

The CPU 20 of the computer 2 judges if an operation signal indicating a reproduction start command operation designating a reproduction point has been input from the operation device 19. It proceeds to step ST57 when judging it has been input, while repeats the processing of step ST66 when judging it has not.

Step ST57:

When judging it as input, the CPU 20 of the computer 2 outputs a reproduction start command designating the reproduction point to the CPU 42b of the reproduction apparatus 4b.

Step ST58:

The CPU 42b of the reproduction apparatus 4b schedules the decoding order of a new GOP's worth of picture data and writes the picture property data PP of the picture data in the scheduling buffers 45_1 to 45_3 shown in FIG. 16 in that scheduled order 16. Further, the CPU 42b, as shown in FIG. 18A, sets to valid the validity flag data “valid” of all of the picture property data PP stored in the scheduling buffers 45_1 to 45_3.

Step ST59:

The CPU 42b of the reproduction apparatus 4b determines the reproduction (decode) start time of the picture property data with a valid validity flag data “valid” in the picture property data PP stored in the scheduling buffers 45_1 to 45_3 and determines this as the reproduction start time “time” of the picture property data PP.

Step ST60:

The CPU 42b of the reproduction apparatus 4b judges if the designated reproduction rate is 1× speed or more. If it is 1× speed or more, it proceeds to step ST61, while if otherwise, it proceeds to step ST63.

Step ST61:

The CPU 42b of the reproduction apparatus 4b, in accordance with need (when there is a speed change command etc.), makes valid the validity flag data “valid” of the picture property data of all of the picture data after the picture data reproduced immediately before in the picture property data PP stored in the scheduling buffers 45_1 to 45_3 based on the designated reproduction rate.

Step ST62:

The CPU 42b of the reproduction apparatus 4b calculates the next update timing of the picture data being displayed at the time of less than 1× speed reproduction (slow motion reproduction).

Step ST63:

The CPU 42b of the reproduction apparatus 4b judges if the timing indicated by a not shown timer provided in the reproduction apparatus 4b has become an update timing calculated at step ST62. If it has, it proceeds to step ST66, while if otherwise, it proceeds to step ST73.

Step ST64:

The CPU 42b of the reproduction apparatus 4b judges if a command for changing the reproduction rate has been input. If it has, it proceeds to step ST65, while if otherwise, it proceeds to step ST67.

Step ST65:

The CPU 42b of the reproduction apparatus 4b sets as valid or invalid the validity flag data “valid” of the picture property data PP stored in the scheduling buffers 45_1 to 45_3 in accordance with the changed reproduction rate corresponding to the command for change of the reproduction rate. That is, CPU 42b resets the validity flag data “valid” of the picture property data PP stored in the scheduling buffers 45_1 to 45_3. The CPU 42b, for example, performs the processing as explained using FIG. 18 and FIG. 19.

Step ST66:

The CPU 42b of the reproduction apparatus 4b determines again reproduction (decoding) start time of the picture property data with a valid validity flag data “valid” in the picture property data PP stored in the scheduling buffer 45_1 to 45_3 and sets this for the reproduction start time “time” of the picture property data PP. That is, the CPU 42b resets the reproduction start timing “time” of the picture property data PP based on the results of step ST65. Note that the reset reproduction start timing “time” is for example calculated by adding “1” to the immediately previous reproduction start timing. When a command for change of the reproduction rate is output in the decoding in units of picture data, the reproduction apparatus 4b immediately executes steps ST65 and ST66 and resets the validity flag data “valid” of the picture property data PP stored in the scheduling buffers 45_1 to 45_3. Due to this, according to the reproduction apparatus 4b, it is possible to decode and to reproduce and output data in accordance with the changed reproduction rate in units of picture before the reproduction of the GOPs as a whole is finished. As a result, it is possible to shorten the time from when the reproduction apparatus 4 receives a command for change of the reproduction rate to when reproduction and output corresponding to the changed reproduction rate are actually performed as compared with the past.

Step ST67:

The CPU 42b of the reproduction apparatus 4b successively reads the validity flag data “valid” of the picture property data PP stored in the scheduling buffer selected for processing among the scheduling buffers 45_1 to 45_3. Further, the CPU 42b outputs a decode command for the corresponding picture data to the decoders 34_1 to 34_3 conditional on the read validity flag data “valid” of the picture property data PP indicating valid.

Step ST68:

The decoders 34_1, 34_2, and 34_3 read the picture data indicated by the decode command input at step ST67 from the input memory 32 and write the decoding results in the reproduction memories 36_1 to 36_3.

Step ST69:

The CPU 42b of the reproduction apparatus 4b identifies the decoding results to be reproduced and output next based on the designated reproduction direction the scheduling results, generates a display command indicating the decoding results and a switching command for the selector 38 for the desired reproduction and output, and writes this in the control memory 40.

Step ST70:

The CPU 42b of the reproduction apparatus 4b outputs the display command generated at step ST68 to the decoders 34_1, 34_2, and 34_3 and outputs a switching command to the selector 38.

Step ST71:

The decoders 34_1, 34_2, and 34_3 read the decoding results indicated by the input display command from the reproduction memories 36_1 to 36_3 and output them to the selector 38. Further, the selector 38 switches the decoding results input from the decoders 34_1, 34_2, and 34_3 based on the switching command input at step ST12 to select and reproduce and output them.

Step ST72:

The CPU 42b of the reproduction apparatus 4b sets as invalid the validity flag data “valid” of the picture property data PP corresponding to picture data decoded at step ST71 in the picture property data PP being processed stored in the scheduling buffers 45_1 to 45_3.

Step ST73:

The CPU 20 and CPU 42b judge if the processed picture data is the last picture data in the GOP. If judging it is the last picture data, it proceeds to step ST74, while if otherwise, it proceeds to step ST60 and processes the next picture data.

Step ST74:

The CPU 20 and CPU 42b judges if the GOP to which the picture data processed belongs is the last GOP in the reproduced data ENC. If judging it is the last GOP, they end the processing, while if otherwise, they proceeds to step ST75.

Step ST75:

The CPU 20 of the computer 2 reads the next GOP from the HDD 12 in accordance with the reproduction direction.

Step ST76:

The CPU 20 of the computer 2 outputs the GOP read at step ST75 through the bridge 18 and PCI bus 6 to the reproduction apparatus 4b. The CPU 42b of the reproduction apparatus 4b writes the GOP input from the computer 2 through the PCI bridge 30 to the input memory 32.

Step ST77:

The CPU 20 of the computer 2 outputs a GOP transfer completion notification to the CPU 42b of the reproduction apparatus 4b. The CPU 42b writes the transfer completion notification in the control memory 40.

Step ST78:

The CPU 42b of the reproduction apparatus 4b outputs a preparation completion notification to the CPU 20 of the computer 2.

Step ST79:

The CPU 42b of the reproduction apparatus 4b judges, for example if scheduling has been completed for a GOP including the picture data of the reproduction point next in accordance with the reproduction direction (that is, if scheduling is required). If it judges that the scheduling has not been completed, it proceeds to step ST58, while if otherwise, it proceeds to step ST60.

As explained above, the data processing system 1b, in the same way as the data processing system 1 of the first embodiment, performs decoding scheduling in units of GOPs and determines whether to decode and to reproduce and output the picture data scheduled for decoding in units of picture data at the timing for actually decoding and reproducing and outputting the picture data forming the GOP based on the results of the decoding scheduling and the reproduction rate. Therefore, according to the data processing system 1b, when a command is issued for changing the reproduction rate during reproduction of GOPs, it is possible to decode and reproduce and output data in units of picture data in accordance with the changed reproduction rate before finishing the reproduction of the GOPs. As a result, the time from when the reproduction apparatus 4b receives a command for changing the reproduction rate to when reproduction and output corresponding to that changed reproduction rate are actually performed can be shortened compared with the past. Further, in the data processing system 1b, by just setting (rewriting) the validity flag data “valid” of the picture property data PP stored in the scheduling buffers 45_1 to 45_3, a change in the reproduction rate can be handled. That is, there is no need for processing involving a large processing load such as rearranging the picture property data PP. Therefore, according to the data processing system 1b, changes in speed can be handled by a small processing load and in a short time. This effect is particularly remarkable in the case of employing a long GOP and the case where the number of picture data covered by the scheduling is large.

The present invention is not limited to the above embodiments. In the above embodiments, as the plurality of picture data, MPEG picture data was illustrated, but the present invention may also be applied to audio data so long as it is decoded in order.

Further, in the above embodiments, as the encoding scheme, the MPEG was illustrated, but the invention may be similarly applied to the H.264/AVC (Advanced Video Coding) etc. to the case of decoding data comprised of a first type of picture data where the decoding results are referred to in decoding of other picture data and second type of picture data where the decoding results are not referred to in decoding of other data.

Further, in the above embodiments, it is also possible to generate results of scheduling all picture data in a GOP in the decoding scheduling and property data (flag data) defining whether to set each picture data in all of the picture data valid or invalid in accordance with the reproduction rate and update the property data in accordance with the designated reproduction rate in the decoding and reproduction and output of the picture data. Further, in the decoding and reproduction and output of the picture data, the picture data is decoded and reproduced and output based on the updated property data.

In the above embodiments, the case where compressed picture data was stored in the HDD 12 was explained, but the present invention is not limited to this, for example, can also be applied to storage through an input/output interface etc. on an optical disk, magneto-optic disk, semiconductor memory, magnetic disk, or other various storage media. Further, the mode of connection is not limited to connection through cables etc. For example, connection by other types of connection modes such as connection by wires or wirelessly from the outside is also possible.

Further, in the above embodiments, the case of performing a series of processing by hardware having those functions was explained, but the present invention is not limited to this. Use of software for this is also possible. At this time, when performing a series of processing by software, various types of functions may be realized by installing various programs into the computer in which the program forming that software is built into to dedicated hardware. For example, it is installed in a general use personal computer etc. from for example a storage medium. Further, the storage medium for example includes an optical disk, magneto-optic disk, semiconductor memory, magnetic disk or other various storage media needless to say. Further, for example, it is also possible to install various types of programs in a general personal computer etc. for example by downloading them through the Internet or other networks.

Further, in the above embodiments, the steps describing the program stored in the storage medium may of course be performed in time sequence along the described order of course, but the invention is not limited in time sequence. Performance in parallel or individually is also included.

Further, the above embodiments, the reproduction rate is not particularly limited. The invention may be broadly applied to specific processing of the reproduction apparatus at any variable speed reproduction operations.

Further, the block configurations of the embodiments are examples of the block configurations. The invention is not limited to the illustrated examples.

Further, by suitably providing a group of read flags indicating if the data read from the HDD 12 is valid for the compressed and encoded data stored in the HDD 12, a group of decode flags indicating validity at the time of scheduling of decoding, a group of display flags indicating validity at scheduling for display of the decoded data, etc. as metadata and automatically updating the series of flag groups in accordance with reproduction speed and direction, scheduling can be managed. At this time, the past series of scheduling using variable speed reproduction processing and update information of the groups of flags may be managed as separate scheduling metadata (history information). This may in accordance with need be described as syntax in the compressed and encoded data or separately stored in a storage medium such as the HDD 12.

Further, the number of the decoders, the number of the banks, the decoder IDs, etc. may also be managed as metadata (component history information). Further, the reproduction rate, reproduction direction, etc. may also be managed as metadata (reproduction history information). At this time, the metadata may if necessary be described as syntax in the compressed and encoded data or separately stored in a storage medium such as the HDD 12. By referring to such metadata (history information), it is possible to reuse scheduling performed in the past and further to perform scheduling faster and more accurately. Note that this metadata may also be comprised so as to be managed at an outside apparatus as for example a database.

Note that, in the above embodiments, the present invention can also be applied to a case when the decoders 34-1 to 34-3 do not completely decode the compressed and encoded data stored on the HDD 12 (decode it up the middle). Specifically, for example, the present invention may also be applied to a case where the decoders 34_1 to 34_3 only perform decoding for variable length encoding and inverse quantization and do not perform inverse DCT, a case where they perform inverse quantization, but do not perform decoding for variable length encoding, etc. In such a case, for example, the decoders 34_1 to 34_3 may generate history information indicating for example up to what stage of encoding and decoding (for example, stage of inverse quantization) they performed processing for and output this linked with the incompletely decoded data.

Further, in the above embodiments, the HDD 12 stored incompletely encoded data (for example, data for which DCT and quantization were performed, but for which variable length encoding was not performed) and, in accordance with need, history information of the encoding and decoding, but the present invention may also be applied to the case where the decoders 34_1 to 34_3 can decode incompletely encoded data supplied under the control of the CPU 20 and convert it to a baseband signal. Specifically, the present invention can also be applied to the case where the decoders 34_1 to 34_3 for example perform inverse DCT and inverse quantization for data to which DCT and quantization have been applied, but variable length encoding has not been applied and do not perform decoding for variable length encoding. Further, in such a case, for example, the CPU 20 may obtain the history information of encoding and decoding stored in the HDD 12 linked with the incompletely encoded data and schedule the decoding by the decoders 34_1 to 34_3 based on that information.

Further, in the above embodiments, the HDD 12 stored the incompletely encoded data and, in accordance with need, history information of encoding and decoding, but the present invention may also be applied to the case where the decoders 34_1 to 34_3 do not completely decode the incompletely encoded data supplied under the control of the CPU 20 (decode it only to an intermediate stage). Further, in such a case as well, for example, the CPU 20 may obtain the history data of encoding and decoding stored in the HDD 12 linked with the incompletely encoded data and schedule the decoding by the decoders 34_1 to 34_3 based on this information. In other words, the present invention can be applied even to the case where the decoders 34_1 to 34_3 perform partial decoding under the control of the CPU 20 (execute part of the process of decoding). The CPU 20 obtains the history information of the encoding and decoding stored in the HDD 12 linked with the incompletely encoded data. Based on this information, it is possible to schedule decoding by the decoders 34_1 to 34_3. The decoders 34_1 to 34_3 can also generate the history information of the encoding and decoding in accordance with need and output it linked with the incompletely decoded data. Further, the HDD 12 may further store information on the history of encoding and decoding processing linked with the compressed and encoded stream data, and the CPU 20 may schedule the decoding of the compressed and encoded stream data based on the information on the history of the encoding processing and the decoding processing. Further, even when the decoder 34_1 to 34_3 can decode the compressed and encoded stream data and convert it to a baseband signal under the control of the CPU 20, it is possible to generate the information on the history of encoding and decoding in accordance with need and enable it to be output linked with the baseband signal.

Note that in the above embodiments, the reproduction apparatus 4 was explained as having a plurality of decoders, but the present invention can also be applied to the case of a single decoder. At this time, the single decoder may not only receive, decode, and display or output the compressed and encoded data, but may also, in the same way as explained above, receive the compressed and encoded data, partially decode it up to an intermediate stage, and output it to the outside along with history information of encoding and decoding, receive partially encoded data, decode it, and convert it to a baseband signal for output to the outside, or receive partially encoded data, partially decode it to an intermediate stage, and output it to the outside along with history information of the encoding and decoding.

Further, in the above embodiments, the CPU 20 and CPU 42 were configured separately, but the invention is not limited to this. For example, the CPU 20 and CPU 42 may also conceivably be configured by a single CPU controlling the reproduction apparatus 4 as a whole. Further, even when the CPU 20 and CPU 42 are configured independently, the CPU 20 and CPU 42 may also be formed on a single chip.

Further, when the CPU 20 and CPU 42 are configured independently, it is possible to make at least part of the processing performed by the CPU 20 in the above embodiments be performed for example by time division by the CPU 42 or to make at least part of the processing performed by the CPU 42 be performed by for example time division by the CPU 20. The CPU 20 and CPU 42 may also be realized using processors able to perform dispersed processing.

Further, for example, the reproduction apparatus 4 may be configured to be able to be connected to a network and, in the above embodiments, at least part of the processing performed by the CPU 20 or CPU 42 may be performed at the CPU of another apparatus connected through the network. Similarly, in the above embodiments, the memories 32, 40, etc. were configured separately, but the invention is not limited to this. These memories may conceivably also be configured by a single memory in the reproduction apparatus 4.

Further, in the above embodiments, the case of the HDD 12, the decoders 34_1 to 34_3, and the selector 38 being connected via bridges and buses and made integral as a reproduction apparatus was explained, but the present invention is not limited to this. For example, the invention may also be applied to the case where part of these components are connected by wires or wirelessly from the outside and the case where these components are connected to each other in other various modes of connection.

Further, in the above embodiments, the case of the compressed stream data being stored in an HDD was explained, but the present invention is not limited to this. For example, the invention may also be applied to the case of reproducing and processing stream data stored on an optical disk, magneto-optic disk, semiconductor memory, magnetic disk, or other various storage media.

Further, in the above embodiments, the CPU 42, memory 32, memory 40, decoders 34_1 to 34_3, and the selector 38 were mounted on the same expansion card (for example, PCI card or PCI-Express card), but the invention is not limited to this. For example, PCI-Express or other technology may be used to mount these components on separate expansion cards when the speed of transfer between cards is high.

Further, in this specification, a “system” means a logical collection of a plurality of apparatuses. It does not matter if the apparatuses of the different configurations are in the same housing or not.

The present invention may be applied to a system for reproducing reproduced data.

It should be understood by those skilled in the art that various modifications, combinations sub-combinations, and alterations may occur depending on design requirements and other factors insofar as they are within the scope of the appended claims or the equivalents thereof.

What we claim is:

1. A reproduction apparatus for decoding and reproducing a plurality of picture data forming reproduced data in order, comprising
a reproduction memory,
a decoder for decoding said picture data, writing decoding results in said reproduction memory, and reproducing and outputting said decoding results read from said reproduction memory, and
a processing circuit for performing decoding scheduling for determining an order of decoding said picture data at said decoder in predetermined units of a plurality of said picture data, selecting said picture data to be processed in said order determined by said decoding scheduling, determining whether to decode said selected picture data or reproduce and output the decoding results in accordance with a designated reproduction rate, and controlling said decoding and said reproduction and output of said decoder based on said decision.

2. A reproduction apparatus as set forth in claim 1, wherein said processing circuit performs said decision conditional on said designated reproduction rate being at least 1× speed.

3. A reproduction apparatus as set forth in claim 1, wherein said processing circuit controls said decoding and said reproduction and output of said picture data based on said decision in units of said picture data.

4. A reproduction apparatus as set forth in claim 1, wherein said decoder
reproduces reproduced data, comprised of a first type of picture data where the results of decoding are referred to in decoding of other picture data and a second type of picture data where the decoding results are not referred to in decoding of other picture data, in units of said picture data,
holds the storage of said decoding results of said first type of said picture data in said reproduction memory, and
decodes and reproduces and outputs said second type of picture data while referring to decoding results of said first type of picture data already stored in said reproduction memory.

5. A reproduction apparatus as set forth in claim 4, wherein said decoder decodes said first type of picture data in said plurality of said picture data forming said reproduced data with priority over said second type of picture data decoded with reference to the decoding results of said first type of picture data.

6. A reproduction apparatus as set forth in claim 5, wherein
said apparatus has as said first type of picture data I picture data decoded without referring to the decoding results of other picture data and P picture data decoded referring to the decoding results of other picture data,
said second type of picture data is B picture data decoded referring to the decoding results of other picture data,
said decoder simultaneously stores and holds in a first storage region of said reproduction memory decoding results of said P picture data and decoding results of said first I picture data positioned between first I picture data with decoding results stored in said memory and second I picture data positioned next in said reproduction direction with respect to said first I picture data in the plurality of said I picture data.

7. A reproduction apparatus as set forth in claim 6, wherein
said reproduction memory has a second storage region, separate from said first storage region, for storing said B picture data, and
said decoder writes decoding results of said reproduced and output B picture data over decoding results of other B picture data in order until finishing decoding all B picture data positioned between said first I picture data and said second I picture data.

8. A reproduction apparatus as set forth in claim 4, further comprising:
a plurality of said decoders for processing said reproduced data in parallel,
a plurality of said reproduction memories provided corresponding to said plurality of decoders, and
a processing circuit for making said decoders decode said picture data so that said second type of picture data referring to the decoding results of the same first type of picture data are decoded by the same decoder and said first type of picture data included in said group of picture data are decoded by the same decoder.

9. A reproduction apparatus as set forth in claim 8, wherein said processing circuit makes said plurality of decoders decode pluralities of groups of picture data each comprised of a plurality of picture data consecutively reproduced and output by different decoding circuits.

10. A reproduction apparatus as set forth in claim 9, wherein said decoders write decoding results of said first type of picture data of a first group of picture data over decoding results of said first type of picture data of a second group of picture data decoded by said decoders right before said first group of picture data stored in said reproduction memory.

11. A reproduction apparatus as set forth in claim 1,
said apparatus defining picture property data indicating whether to decode said picture data for each said picture data and
comprising a control storage means for storing said picture property data of said plurality of picture data, and
said decoder determining whether to decode said picture data corresponding to said picture property data based on said picture property data read from said control storage means.

12. A reproduction apparatus as set forth in claim 11, wherein said decoder updates said picture property data stored in said control storage means in accordance with a designated reproduction rate.

13. A reproduction apparatus as set forth in claim 12, wherein said decoder updates a reproduction timing of said picture data corresponding to said picture property data indicating decoding each time updating said picture property data.

14. A data processing system comprising:
a data processing apparatus for outputting a plurality of picture data forming reproduced data to a reproduction apparatus and
a reproduction apparatus for successively decoding and reproducing a plurality of picture data input from said data processing apparatus,
said reproduction apparatus comprising:
an input memory for storing said picture data input from said data processing apparatus,
a reproduction memory,
a decoder decoding said picture data read from said input memory, writing the decoding results in said reproduction memory, and reproducing and outputting said decoding results read from said reproduction memory, and
a processing circuit for performing decoding scheduling for determining the order of making said decoder decode said picture data in units of a predetermined plurality of said picture data, selecting said picture data to be processed in said order determined by said decoding scheduling, determining whether to decode said selected picture data or reproduce or output the decoding results in accordance with a designated reproduction rate, and controlling the decoding and the reproduction and output of said decoder based on that determination.

15. A reproduction method for successively decoding and reproducing a plurality of picture data forming reproduced data, comprising:
a first step of performing decoding scheduling for determining an order of decoding said picture data in units of a predetermined plurality of said picture data,
a second step of selecting said picture data to be processed in the order determined by said decoding scheduling at said first step,
a third step of determining whether to decode said picture data selected at said second step or reproduce and output the decoding results in accordance with a designated reproduction rate, and
a fourth step of controlling said decoding and the reproduction and output of said decoding results based on the determination of said third step.

16. A reproduction method as set forth in claim 15, wherein said third step determines whether to decode said picture data corresponding to said picture property data based on picture property data indicating whether to decode said picture data defined for each said picture data.

17. A reproduction method comprising:
a first step for outputting a plurality of picture data forming reproduced data from a data processing apparatus to a reproduction apparatus,
a second step of having said reproduction apparatus perform decoding scheduling for determining an order of decoding picture data input from said data processing apparatus in said first step in units of a predetermined plurality of said picture data,
a third step of selecting said picture data being processed in the order determined by said decoding scheduling performed at said second step,
a fourth step of determining whether or not to decode said picture data selected at said third step or reproduce and output the decoding results in accordance with a designated reproduction rate, and
a fifth step of controlling said decoding and said reproduction and output of said decoding results based on the determination at said fourth step.

18. A program executed by a reproduction apparatus successively decoding and reproducing a plurality of picture data forming reproduced data, comprising
a first routine of performing decoding scheduling for determining an order of decoding picture data in units of a predetermined plurality of said picture data,
a second routine of selecting said picture data being processed in the order determined by said decoding scheduling performed at said first routine,
a third routine of determining whether or not to decode said picture data selected at said second routine or reproduce and output the decoding results in accordance with a designated reproduction rate, and
a fourth routine of controlling said decoding and said reproduction and output of said decoding results based on the determination at said third routine.

19. A storage medium storing a program executed by a reproduction apparatus successively decoding and reproducing a plurality of picture data forming reproduced data, said program comprising
a first routine of performing decoding scheduling for determining an order of decoding picture data in units of a predetermined plurality of said picture data,
a second routine of selecting said picture data being processed in the order determined by said decoding scheduling performed at said first routine,
a third routine of determining whether or not to decode said picture data selected at said second routine or reproduce and output the decoding results in accordance with a designated reproduction rate, and
a fourth routine of controlling said decoding and said reproduction and output of said decoding results based on the determination at said third routine.

20. A data processing apparatus comprising:
a storage medium storing a plurality of picture data forming reproduced data,
a reading means for reading said picture data from said storage medium,
an input memory for storing said picture data read by said reading means,
a reproduction memory,
a decoder for decoding said picture data read from said input memory, writing the decoding results in said reproduction memory, and reproducing and outputting said decoding results read from said reproduction memory, and
a processing circuit for performing decoding scheduling for determining the order of making said decoder decode said picture data in units of a predetermined plurality of said picture data, selecting said picture data to be processed in said order determined by said decoding scheduling, determining whether to decode said selected picture data or reproduce or output the decoding results in accordance with a designated reproduction rate, and controlling the decoding and the reproduction and output of said decoder based on that determination.
